(19) United States
(12) Patent Application Publication
(10) Pub. No.: US 2022/0177693 A1
(43) Pub. Date: Jun. 9, 2022

(54) METHOD OF EPOXIDATION

(71) Applicant: University of Durham, Durham (GB)

(72) Inventor: Lian Richard Hutchings, Durham (GB)

(21) Appl. No.: 17/604,614

(22) PCT Filed: Apr. 16, 2020
(86) PCT No.: PCT/EP2020/060711

§ 371 Date: Oct. 18, 2021

(30) Foreign Application Priority Data
Apr. 16, 2019 (GB) 1905379.2

(51) Int. Cl. C08L 53/02; C08F 212/08; C08F 236/08; C08F 236/22; C08F 236/06; C08F 297/04; B60C 1/00

(52) U.S. Cl. CPC C08L 53/025; C08F 212/08; C08F 236/08; B60C 1/0016; C08F 236/06; C08F 297/046; C08F 236/22

(57) ABSTRACT

The present invention concerns block and/or tapered block copolymers comprising pendant hydrocarbyl, trisubstituted epoxide-containing moieties, and methods of preparing these and their precursors. The invention also concerns curable compositions comprising such copolymers as modified solution styrene butadiene rubbers and silica and/or carbon black and articles formed from curing these formulations. Such articles may be tyres.

### FIELD OF THE INVENTION

The present invention concerns block and/or tapered block copolymers comprising pendant hydrocarbyl, trisubstituted epoxide-containing moieties, and methods of preparing these and their precursors. The invention also concerns curable compositions comprising such copolymers as modified solution styrene butadiene rubbers and silica and/or carbon black and articles formed from curing these formulations. Such articles may be tyres.

### BACKGROUND OF THE INVENTION

Synthetic copolymer rubbers are widely used in the automotive, footwear, adhesives, textiles and biomedical fields. These rubbers can be reinforced using fillers such as silica and/or carbon black. Reinforced synthetic rubbers have a greater resilience to stress, and are useful in the manufacture of articles that typically suffer from wear, for example tyres, shoe soles, gaskets etc. Silica is commonly used as filler in tyres because it significantly improves wet-traction and rolling resistance properties (see for example U.S. Pat. No. 5,227,425, Rauline). However, silica is highly polar, which leads to poor compatibility with nonpolar rubbers, and processing difficulties. Silica particles are prone to aggregation via hydrogen-bonding, which results in poor dispersion of silica throughout the rubber, and poor properties, for example, hardening of the rubber (see for example W. Kaewsakul et al., J. Elastomers Plast., 2016, 48(5), 426-441). Other fillers, such as carbon black, are also prone to such compatibility and processing issues.

Several processes to improve silica dispersion are known, including optimization of mixing procedures, silica surface treatments, and the use of polar, functionalised rubbers (which are more compatible with silica). The most widely used method involves the use of coupling agents capable of establishing interactions between the polymer and the filler. However agglomeration of silica can take place during storage (see S. Mihara et al., Rubber Chem. Technol. 2009, 82, 525-540).

Alternatively, modification of the polymer can be carried out by introducing a functional group that binds to the silica and/or carbon black. Typically, synthetic copolymer rubbers are prepared by anionic polymerisation, which is the preferred method to produce copolymers such as solution styrene butadiene. As is well known, anionic polymerisation is a chain-growth polymerisation, which as a consequence of its mechanism proceeds in the absence of chain termination reactions. It is an example of what is commonly known as a ‘living polymerisation’.

It is known that living polymerisations are particularly susceptible to the exercise of control over molecular variables. Sophisticated anionic polymerisations have been developed in order to provide for the synthesis of polymers with controlled molecular weights, narrow molecular weight distributions (low dispersity), block copolymers, end-functionalised polymers and polymers with controlled branched architectures, for example star-branched polymers and dendritically branched polymers. Moreover, there are a number of well-known criteria understood to describe the key attributes of living polymerisations, which a polymerisation mechanism must satisfy in order to be described as a living polymerisation.

Although the term living anionic polymerisation, used interchangeably herein with anionic polymerisation, may sometimes be used rather loosely, living anionic polymerisations, at least from a commercial perspective and without further description or qualification, are often understood to typically involve the use of an alkyl lithium, most commonly a butyl lithium, as the polymerisation initiator. Anionic polymerisation is the methodology commonly used for the polymerisation of butadiene, isoprene or styrene, or for the copolymerisation of two or more of these monomers, generally by effecting (co)polymerisation in one or more non-polar, aprotic solvents. This notwithstanding, a much wider variety of monomers, including numerous derivatives of butadiene, isoprene and styrene as well as acrylates, methacrylates, vinyl pyridine and various cyclic monomers including ethylene oxide and hexamethylcyclotrisiloxane, have been polymerised using anionic polymerisation.

One of the most significant limitations of living anionic polymerisation is the reactivity of the propagating anion and its tendency to act as a strong base and nucleophile. This leads to reaction and subsequent termination of propagation when the living polymer comes into contact with, inter alia, water, oxygen and carbon dioxide (all of which are found in air) and many otherwise useful electron-deficient or polar functional groups including alcohols, carboxylic acids, and primary and secondary amines.

Such functional groups may be introduced via end-functionalisation or in-chain functionalisation, which typically occur through the use of initiators, terminators and/or monomers containing protected functional groups. However, this requires the synthesis of such protected reagents as well as an additional deprotection step following polymerisation. For a review of advances in anionic polymerisation, see K. L. Hong et al., Curr. Opin. Solid State Mater. Sci., 1999, 4(6), 531-538. An article published by the Campos-Covarrubias group describes the end-functionalisation of polymyrcene, synthesised by anionic polymerisation, with silyl protected amines to produce polymyrcenes with primary amine end-group functionality (see A. Avila-Ortega et al., J. Polym. Res., 2015, 22, 226). Alternatively, the polar functional group may be introduced post-polymerisation via transformation of a non-polar moiety to a polar moiety. In US 2017/0313789 A1 (Rannoux et al.), the synthesis of polymers bearing hydroxyaryl groups is described, in which polymers synthesised by radical polymerisation of monomers bearing pendant epoxide functional groups are reacted with nucleophiles (amines and carboxylic acids) bearing the hydroxyaryl groups.

Alternatively, unsaturated bonds within a polymer may be functionalised after polymerisation. A recent publication by the Schlaad group describes the post-polymerisation in-chain functionalisation of polymyrcene, synthesised by anionic polymerisation of β-myrcene, via photochemical functionalisation with various thiols, using benzophenone/UV light as the radical source (see A. Matic and H. Schlaad, Polym. Int., 2018, 67, 500-505).

A recent publication by the Saha group describes the interactions of silica with solution styrene butadiene rubber modified with epoxidised soybean oil (ESO), and epoxidised natural rubber (see M. C. Kim et al., Journal of Cleaner Production, 2019, 208, 1622-1630). The soy bean oil was epoxidised prior to reaction with solution styrene butadiene. The tensile properties of blends of solution styrene butadiene modified with epoxidised soybean oil, and epoxidised natural rubber were found to be better than those of blends with non-modified solution styrene butadiene and/or non-epoxidised natural rubber. The improved properties were attributed to the ring-opening of the epoxy groups during vulcanisation with silica filler particles, which led to the formation of single bonds to the silica filler.

The Bhowmick group have synthesised bipolymers of myrcene with styrene, dibutyl itaconate, butyl methacrylate, or glycidyl methacrylate via emulsion polymerisation (a type of radical polymerisation) (see P. Sarkar and A. K. Bhowmick, ACS Sustainable Chem. Eng., 2016, 4, 5462-5474; P. Sarkar and A. K. Bhowmick, Ind. Eng. Chem. Res., 2018, 57, 5197-5206; and P. Sahu, P. Sarkar, and A. K. Bhowmick, ACS Sustainable Chem. Eng., 2018, 6, 6599-6611). In the study of bipolymers containing myrcene and glycidyl methacrylate, it was found that the presence of epoxy groups effectively improved the dispersion of silica in the vulcanized bipolymer/silica polymer matrix because of covalent interactions between the silica and the vulcanized bipolymer. In particular, it was found that the epoxy groups ring-opened on vulcanization and reacted with the hydroxy groups on the silica particles.

A recent publication by the Y. Li group describes the synthesis of bio-based, linear comb poly(β-myrcene)-graft-poly(_{L}-lactide) (PM-g-PLLA) copolymers consisting of an interior rubbery block and an exterior semi-crystalline block via ring-opening polymerisation of _{L}-lactide using hydroxylated poly(β-myrcene) as macroinitiator. The hydroxylated poly(β-myrcene) is synthesised via epoxidation of poly(β-myrcene) using hydrogen peroxide and formic acid, followed by acid-catalysed hydrolysis (see C. Zhou et al., Polymer, 2018, 138, 57-64).

US patent publication number US 2019/0055336 A1 (CHAO et al.) and WO 2014/157624 A1 (KURARAY CO., LTD. and AMYRIS, INC.) describe the epoxidation of statistical farnesene polymers so as to provide low-viscosity polymers useful as compositions of adhesives. The copolymers of US 2019/0055336 A1 are also useful as coatings, sealants and elastomers.

To improve silica dispersion and rubber resilience, whilst avoiding potential detrimental effects on other properties, for example the glass transition temperature (T_{g}) of the polymer, it is desirable to be able to provide a polymer containing a controllable (and typically small) number of in-chain, pendant polar groups. Therefore, providing methods of controllably functionalising polymers is of benefit to the art. The present invention seeks to address this issue.

### SUMMARY OF THE INVENTION

The present invention provides copolymers containing pendant epoxide-containing moieties, produced via epoxidation of a first copolymer which is a block and/or tapered block copolymer derived from at least three different types of monomer and which comprises hydrocarbyl, trisubstituted ethylene-containing moieties. Epoxidation via this method is selective at the hydrocarbyl, trisubstituted ethylene-containing moieties, as opposed to disubstituted ethylene motifs, for example, resulting in selective functionalisation. The copolymers containing pendant hydrocarbyl, trisubstituted epoxide-containing moieties may be synthesised from copolymer precursors comprising pendant hydrocarbyl, trisubstituted ethylene-containing moieties. These precursors may be, and typically are, synthesised by living anionic polymerisation.

Functionalising the pendant hydrocarbyl, trisubstituted ethylene-containing moieties (via, for example, epoxidation optionally with ring-opening) affords a copolymer with functionality that may be advantageously clustered at one or at both ends of the chain. Such chain ends may interact with the filler particles, and, in the case of compositions for use in tyres, this may be expected to lead to better rolling resistance of the tyre and better fuel efficiency of vehicles equipped with such tyres.

The present invention thus provides control and flexibility in introducing polar groups within the copolymer chain and/or at the living end of the copolymer.

Viewed from a first aspect, the present invention provides a method comprising effecting an epoxidation reaction on a first copolymer, to provide a second copolymer comprising epoxide groups, wherein the first copolymer is a block and/or tapered block copolymer which is derived from at least three different types of monomer and comprises a backbone from which hydrocarbyl, trisubstituted ethylene-containing moieties are pendant.

Viewed from a second aspect, the present invention provides a copolymer obtainable according to the method of the first aspect of the invention.

Viewed from a third aspect, the present invention provides a method of preparing a copolymer by anionic polymerisation, wherein the copolymer is a first copolymer as defined in the first aspect, and the anionic polymerisation is conducted in the presence of a randomising agent.

Viewed from a fourth aspect, the present invention provides a copolymer, which is a first copolymer obtainable by the method of the third aspect of the invention.

Viewed from a fifth aspect, the present invention provides a curable composition comprising:
(i) the copolymer of the second aspect of the invention, which is a solution styrene butadiene rubber; and
(ii) a filler material.

Viewed from a sixth aspect, the present invention provides an article resultant from curing of the composition of the fifth aspect of the invention.

Further aspects and embodiments of the present invention will be evident from the discussion that follows below.

### BRIEF DESCRIPTION OF THE FIGURES

FIG. 1 is a ¹H NMR spectrum and proton assignment of a poly(butadiene) sample (PB1), wherein the proton labels are as defined in Scheme (2) and the integration values are given beneath the corresponding signal (see Examples, IV.)

FIG. 2 is a ¹H NMR spectrum and proton assignment of a poly(myrcene) sample (PM1), wherein the proton labels are as defined in Example XVII.II and the integration values are given beneath the corresponding signal.

FIG. 3 is a ¹H NMR spectrum of a poly(ocimene) sample (POc1), wherein the proton labels are as defined in the inset and the signals for the 1,4- and 1,2-microstructures are assigned.

FIG. 4 consists of overlaid ¹H NMR spectra of epoxidised (top) and unepoxidised (bottom) poly(myrcene) sample (PM1), wherein the proton labels are as defined in Scheme (8) and the integration values are given beneath the corresponding signal (see Examples, IX.1) FIG. 5 depicts a Differential Scanning Calorimetry (DSC) thermogram comparing entries 1 and 2 of Table 4. Entries 1 and 2 are I/4MS diblock copolymers comprising 50% isoprene and 50% 4-methylstyrene. Entry 1 is unepoxidised and corresponds to the lower line and entry 2 is epoxidised and corresponds to the higher line (see Examples, XII.IV).

FIG. 6 is a ¹H-NMR spectrum of an epoxidised polymyrcene sample (EPM10), wherein the proton labels are as defined in the inset (shown only for the dominant 4,1 microstructure).

FIG. 7 is a ¹H NMR spectrum of an epoxidised poly(ocimene) sample (EPOc1), wherein the proton labels are as defined in the inset and the signals for the 1,4- and 1,2-microstructures are assigned.

FIG. 8 is a ¹H NMR spectrum of a poly(butadiene)-poly(ocimene) block copolymer (PB-b-Oc1), wherein the proton labels are as defined in the inset and the signals for the 1,4- and 1,2-microstructures of the polyocimene residues and the 1,4-trans, 1,4-cis and 1,2-microstructures of the polybutadiene residues are assigned.

FIG. 9 is a ¹H NMR spectrum of an epoxidised poly(butadiene)-poly(ocimene) block copolymer (PB-b-Oc1), wherein the proton labels are as defined in the inset and the signals for the specific microstructures are assigned.

FIG. 10 is a ¹H NMR spectrum of an epoxidised poly(butadiene) sample (EPB1), wherein the proton labels are as defined in the inset and the signals for the specific microstructures are assigned.

FIG. 11 is a ¹H-NMR spectrum of a ring-opened epoxidised polymyrcene sample (ROEPM10), wherein the proton labels are as defined in the inset (shown only for the dominant 4,1 microstructure).

### DETAILED DESCRIPTION OF THE INVENTION

Effecting an epoxidation reaction according to the method of the first aspect of the invention, gives rise to selective epoxidation of the pendant ethylene moieties. This method is described below in detail.

In the discussion that follows, reference is made to a number of terms, which are to be understood to have the meanings provided below, unless a context indicates to the contrary. The nomenclature used herein for defining compounds, in particular the compounds described herein, is intended to be in accordance with the rules of the International Union of Pure and Applied Chemistry (IUPAC) for chemical compounds, specifically the “IUPAC Compendium of Chemical Terminology (Gold Book)” (see A. D. Jenkins et al., Pure & Appl. Chem., 1996, 68, 2287-2311). For the avoidance of doubt, if a rule of the IUPAC organisation is contrary to a definition provided herein, the definition herein is to prevail.

The term “comprising” or variants thereof will be understood to imply the inclusion of a stated element, integer or step, or group of elements, integers or steps, but not the exclusion of any other element, integer or step, or group of elements, integers or steps.

The term “consisting” or variants thereof will be understood to imply the inclusion of a stated element, integer or step, or group of elements, integers or steps, and the exclusion of any other element, integer or step or group of elements, integers or steps.

The term “copolymer” is well known in the art and defines a polymer derived from more than one type of monomer. The skilled person is aware that copolymers obtained by copolymerisation of two, three or four different monomer types may be termed bipolymers, terpolymers, and quaterpolymers respectively.

The presence of more than one type of monomer in copolymers may be manifested in a wide variety of copolymer structures, even within bipolymers, depending upon the sequence and distribution of the two kinds of monomer within the resultant copolymer. For example, use of two comonomers gives rise to the possibility of block copolymers, which comprise “blocks” of the same type of comonomer, and which may be further subdivided into di-block copolymers (with two blocks—one comprising each comonomer) or multi-block copolymers (with more than two “blocks”, which may be graft block copolymers, e.g. where blocks derived from one comonomer are grafted onto a block derived from the other comonomer); statistical copolymers, which may comprise random or designed distributions of the comonomers (for example statistical copolymers may have two alternating comonomers (as opposed to blocks comprising two alternative comonomers) or tapering of comonomer distribution within the copolymer, with increasing units of one comonomer to one end of the copolymer, forming a tapered block). Obviously, it will be appreciated that further complexity is possible with three or more comonomers, for example terpolymers, although the same principles apply. For the avoidance of doubt, a copolymer derived from three monomers may be a di-block copolymer, in which one block comprises one type of monomer, and the other comprises a random or designed distribution of the other two types of monomer, i.e. the second block comprises a statistical copolymer. In more detail:
Block copolymers can be di-block, tri-block or multi-block and contain repeated sequences of a particular monomer—called a block—followed by one or more blocks of other monomers.
   Adjacent blocks within block copolymers are constitutionally different, i.e. adjacent blocks comprise constitutional units either derived from different species of monomer, or from the same species of monomer but with a different composition or sequence distribution of constitutional units. For example, where a polymer is a terpolymer derived from monomer units A, B and C, it may be a triblock terpolymer, for example, with the following distribution of comonomers:
      AAAAAAAAABBBBBBBBCCCCCCCCCCC,
in which each type of monomer unit is distributed in a separate block, giving rise to a three blocks: one block comprising monomer units A, one block comprising monomer units B, and the other block comprising monomer units C.
   Alternatively, a terpolymer derived from monomer units A, B and C may be a diblock terpolymers, for example with the following distribution of comonomers:
      ABABABABABABABABABABABABCCCCCCCC,
in which monomer units A and B are distributed in one block comprising alternating units of A and B, and monomer C is distributed in one block comprising only monomer units C.
   Another example of comonomer distribution in a diblock terpolymer derived from monomer units A, B and C is:
      ABCABCABCABCABCABCABCAABAACAABAACAABAAC,
in which monomer units A, B and C are distributed in one block comprising alternating units of A, B and C in a ratio of 1:1:1, and in another block comprising alternating units of A, B and C in a ratio of 4:1:1.
   Block copolymers can be linear or branched. Hereinafter, the invention is discussed primarily with respect to linear polymers, which by definition have two ends. However, it will be understood that the teachings herein may be modified to account for branched copolymers having more than two ends. When a copolymer is branched, the references herein to “both ends”, “each end” or “opposite ends” refer to two of the more than two ends present in the copolymer. Linear block copolymers are prepared by the sequential addition of monomers. For example, monomer A is added to the initiator and allowed to polymerise until all of monomer A is consumed. The “living” nature of the anionic mechanism means that the propagating chain end remains active such that when a batch of a second monomer B is added to the living polymer, propagation recommences and a block of B grows and is covalently attached to block A.
Statistical copolymers are copolymers in which two (or more) monomers are polymerised simultaneously. The resultant sequence depends on the relative reactivity preferences of the co-monomers—their reactivity ratio—and the resultant copolymer may have a distribution of comonomers in which the two (or more) monomers are arranged in a sequence that is strictly alternating, random or tapered.

A tapered block copolymer is a copolymer in which the distribution of comonomers within the copolymer has a gradient distribution, with an increasing proportion of one comonomer to one end of the comonomer. The use of two comonomers with starkly different reactivities can give rise to a tapering distribution that results in a block-like distribution characteristic of a tapered block copolymer. Thus, with two such comonomers, a first monomer may polymerise with a strong propensity to afford a block which comprises predominantly the first monomer; a second block follows that comprises both the first monomer and a second monomer with a compositional gradient moving from a greater proportion of the first monomer to a greater proportion of the second monomer; and a third block which comprises predominantly the second monomer. A typical example arises from the anionic copolymerisation of butadiene and styrene in a non-polar solvent such as benzene (see H. L. Hsieh and R. P. Quirk, Anionic Polymerization: Principles and Practical Applications, Marcel Dekker, Inc., New York, 1^{st}Edition, 1996).

Where a polymer is a terpolymer derived from monomer units A, B and C, it may be a tapered block terpolymer, for example with the following distribution of comonomers:
ABAABABBABABABAABBACBABCABCACBCCCCCCCC,

in which monomer units A and B are distributed in a block comprising predominantly a random distribution of monomer units A and B. A second block follows that comprises monomer units A, B and C, with the proportion of A and B decreasing across the block and the proportion of C increasing across the block. This is then followed by a block comprising predominantly monomer C.

Another example of a comonomer distribution of a tapered block terpolymer derived from monomer units A, B and C, is as follows:
AAAAAAABAABABBBBBBBCBBCBCCCCCC,

in which monomer units A are distributed in a block comprising predominantly monomer unit A. A second block follows that comprises both monomer units A and B, with the proportion of A decreasing and the proportion of B increasing across the block.

This is followed by a third block comprising predominantly monomer unit B. A fourth block then follows that comprises both monomer units B and C with the proportion of B decreasing and the proportion of C increasing across the block, and this is finally followed by a fifth block comprising predominantly monomer unit C.

The first, and thus second and third, copolymer of the invention is:
(i) a block copolymer;
(ii) a tapered block copolymer; or
(iii) a block and tapered block copolymer

A copolymer which is a “block and tapered block copolymer” comprises both blocks and tapered blocks. For example, a terpolymer which is a block and tapered block copolymer may comprise a first type of monomer unit adjacent to a block of a second type of monomer unit, which tapers into a block of a third type of monomer unit. For example, where a polymer is a terpolymer derived from monomer units A, B and C, it may be a block and tapered block terpolymer with the following distribution of comonomers:
AAAAAAAABBBBBBBBCBBCBCCCCCCC,

in which monomer units A are distributed in a block, followed by a block comprising predominantly monomer unit B. A third block follows that comprises both monomer units B and C, with the proportion of B decreasing and the proportion of C increasing across the block. This is followed by a fourth block that comprises predominantly monomer unit C.

Styrene and butadiene are commonly used as comonomers for the commercial production of copolymers via anionic polymerisation. The resultant copolymers may have linear or branched architectures and be block, tapered block or random copolymers.

When the polymerisation of styrene and butadiene is carried out in a non-polar solvent, such as benzene or cyclohexane, the result is typically a tapered block copolymer. This is because, in non-polar solvents, the polymerisation of butadiene is strongly favoured over styrene. However, for particular applications, such as use for tyre treads, a random copolymer of styrene and butadiene is often preferred. To try to achieve this randomness, polar additives are routinely added to the polymerisation, particularly in the preparation of a copolymer commonly used in such applications: solution styrene butadiene rubber (sSBR). sSBR is a well-understood term, which denotes a styrene butadiene rubber (SBR) prepared by anionic living polymerisation of styrene and butadiene. However, the skilled person will understand that sSBRs may arise from copolymerisation of butadiene and styrene with additional comonomers, which other comonomers in the present invention (for example in its fifth aspect) give rise to the pendant hydrocarbyl, trisubstituted ethylene-containing moieties.

In polar solvents, such as THF, the polymerisation of styrene is favoured over butadiene, however, the addition of ethers or tertiary amines (such as ditetrahydrofurylpropane (DTHFP) or tetramethylethylenediamine (TMEDA)) as randomisers to a non-polar solvent such as benzene or cyclohexane achieves a random arrangement of styrene and butadiene in the copolymer chain (H. L. Hsieh and R. P. Quirk, supra). Tetramethylethylenediamine is also known as N,N,N′,N′-tetramethylethylenediamine and these names are used interchangeably herein. Ditetrahydrofurylpropane is also known as 2,2-di(tetrahydrofuryl)propane and these names are used interchangeably herein.

Although the invention is discussed herein with particular reference to sSBR, comprising architecture resultant from additional comonomers, such as myrcene, which provide the hydrocarbyl, trisubstituted ethylene-containing moieties present in the first copolymers described herein, it is to be understood that the discussion of such embodiments is illustrative, rather than limitative, of the invention.

Control over the incorporation into a copolymer of comonomers is desirable since each contributes different characteristics, and so the ratio between the two monomers will influence the properties of the copolymer. Generally sSBR comprises from about 10 to about 25% of styrene. The absence of styrene blocks improves certain properties in tyres made using sSBR, such as abrasion and rolling resistance. The material becomes harder and less rubbery, however, when the ratio of styrene is increased.

Randomisers regulate the randomisation and tapering of comonomer sequences during copolymerisation. The selection of randomiser and the amount employed can influence the degree and direction of taper in the distribution of styrene and butadiene.

The term “star polymer” defines a polymer composed of star macromolecules, i.e. a macromolecule containing a single branch point from which linear chains emanate.

The term “dendritically branched polymer” defines a hierarchically branched polymer with a tree-like structure.

The term “epoxide” defines a saturated three-membered cyclic ether. The simplest epoxide is oxirane.

The term “backbone”, when used in connection with copolymer compounds, may be used interchangeably with the term “main chain” and defines a linear chain to which all other chains may be regarded as being pendant. The copolymer, and its backbone, arises consequential to polymerisation.

The term “hydrocarbyl” defines all univalent groups formed by removing a hydrogen atom from a hydrocarbon. The term “hydrocarbon” is equally well known and means herein all aliphatic and aromatic compounds consisting of carbon and hydrogen only, including branched and unbranched alkanes, cycloalkanes, alkenes, cycloalkenes and alkynes.

The term “aromatic” defines a cyclically conjugated molecular entity (which may comprise heteroatoms) with a stability (due to delocalisation) significantly greater than that of a hypothetical localised structure. The Huckel rule is often used in the art to assess aromatic character; monocyclic planar (or almost planar) systems of trigonally (or sometimes digonally) hybridised atoms that contain (4n+2) π-electrons (where n is a non-negative integer) will exhibit aromatic character. The rule is generally limited to n=0 to 5.

The term “conjugated” or variants thereof defines a molecular entity whose structure may be represented as a system of alternating single and multiple bonds. In such systems, conjugation is the interaction of one p-orbital with another across an intervening σ-bond in such structures. In appropriate molecular entities d-orbitals may be involved. The term is also extended to the analogous interaction involving a p-orbital containing an unshared electron pair.

The term “delocalised” defines the π-bonding in a conjugated system where the bonding is not localised between two atoms, but instead each link has a fractional double bond character, or bond order.

The term “aliphatic” defines acyclic or cyclic, saturated or unsaturated organic (i.e. carbon-containing) compounds that may contain heteroatoms, excluding aromatic compounds.

The term “substituted” means that the corresponding radical, group or moiety has one or more substituents. Where a radical has a plurality of substituents, and a selection of various substituents is specified, the substituents may be selected independently of one another and do not need to be identical.

The term “hydrocarbyl, trisubstituted ethylene-containing moieties” refers to moieties containing a substituted ethylene of formula RR′C═CR″H, wherein two of the R, R′ and R″ are hydrocarbyl groups and the other is a hydrocarbylene group connecting the ethylene moiety to the copolymer backbone.

The term “hydrocarbylene” is used herein to define a divalent group formed by removing two hydrogen atoms from a hydrocarbon, the free valencies of which are not engaged in a double bond.

The term “monoterpene” defines any dimer of isoprenoid precursors.

The term “dispersity” (Ð) is a measure of the dispersion of a molar mass, relative-molecular-mass, molecular weight, or degree-of-polymerisation distribution (see R. G. Gilbert et al., IUPAC, Pure and Applied Chemistry, 2009, 81, 351-353). For a uniform polymer, Ð is 1. The molar-mass dispersity, Ð_{M} defines a value equal to:

$${Ð}_{M} = \frac{{M}_{W}}{{M}_{n}}$$

wherein, M_{w} is equal to the weight average molar mass and Mₙ is equal to the number average molar mass.

The term “weight average molar mass” (M_{w}) may be used interchangeably with the term “mass average molar mass” and defines a value equal to:

$${M}_{W} = \frac{\sum {M}_{i}^{2} {N}_{i}}{\sum {M}_{i} {N}_{i}}$$

wherein, Mᵢ is equal to the molar mass of a polymer chain comprising i repeat units, and Nᵢ is equal to the number of molecules, or number of moles of molecules of molar mass Mᵢ.

The term “number average molecular weight” (Mₙ) may be used interchangeably with the term “number average molar mass” and defines a value equal to:

$${M}_{n} = \frac{\sum {M}_{i} {N}_{i}}{\sum {N}_{i}}$$

The term “number average degree of polymerisation” (Xₙ) defines a value equal to:

$${X}_{n} = \frac{{N}_{0}}{N}$$

wherein, N₀ is equal to the number of molecules before polymerisation and N is equal to the number of molecules at a time, t, after initiation.

When reference is made to a polymer, for example a copolymer, comprising or consisting (or indeed consisting essentially of) one or more types of monomer it will be understood that this is not meant literally, since such co(monomers) are not present, as such, in polymers. Rather, the skilled person will understand that such polymers are made from such co(monomers).

The method of the first aspect of the invention comprises effecting an epoxidation reaction on a first copolymer, to provide a second copolymer comprising epoxide groups. Epoxidation reactions are well known in the art and are the chemical reaction by which an epoxide is synthesised, typically (and herein) from an unsaturated compound. Epoxides can be synthesised by reacting functional groups such as vinyl groups, with oxidants (e.g. peroxides). The method of the first aspect of the invention comprises reacting a first copolymer comprising a backbone from which hydrocarbyl, trisubstituted ethylene-containing moieties are pendant. Epoxidation of ethylene moieties is well known in the art and methods of such epoxidation utilising different nucleophiles have been reported, including the use of metal catalysts, such as silver with oxygen, and the use of vanadyl acetylacetonate with tert-butyl hydroperoxide (see N. Indictor and W. F. Brill, Journal of Organic Chemistry, 1965, 30(6), 2074-2075).

The first copolymer epoxidised in the first aspect of the invention may be any block and/or tapered block copolymer which is derived from at least three different types of monomer and comprises a backbone from which hydrocarbyl, trisubstituted ethylene-containing moieties are pendant. The pendant hydrocarbyl, trisubstituted ethylene-containing moieties arise from copolymerisation of two or more different monomers, wherein at least one of the two or more comonomers give rise to the hydrocarbyl, trisubstituted ethylene-containing moieties. Monomers that cannot give rise to pendant hydrocarbyl, trisubstituted ethylene-containing moieties, i.e. which may be incorporated into the first copolymer described herein, and thus the copolymer of the first to sixth aspects of the invention, include butadiene, styrene and derivatives thereof; isoprene, 2,3-dimethylbutadiene, 2-methyl-1,3-pentadiene; and ethylene glycol, N-vinyl pyrrolidone, cellulose, lactic acid, glycolic acid, caprolactone, and certain anhydrides, orthoesters, phosphoesters, phosphazenes, cyanoacrylate, and derivatives thereof.

The pendant hydrocarbyl, trisubstituted ethylene-containing moieties may arise from copolymerisation of monomers having 6 to 30 carbon atoms, commonly 6 to 15 or 6 to 10 carbon atoms, typically 10 to 15 carbon atoms and preferably 10 or 15 carbon atoms. Most preferably, the hydrocarbyl, trisubstituted ethylene-containing moieties arise from monomers having 10 carbon atoms.

The pendant hydrocarbyl, trisubstituted ethylene-containing moieties may arise from copolymerisation of any one or a combination of 4-7-methyl-3-methylene-1,6-octadiene (β-myrcene, used interchangeably herein with “myrcene”), (E)-7,11-dimethyl-3-methylenedodeca-1,6,10-triene (trans-β-farnesene), (3E,6E)-3,7,11-trimethyldodeca-1,3,6,10-tetraene (trans, trans-α-farnesene), (3Z,6E)-3,7,11-trimethyldodeca-1,3,6,10-tetraene (cis, trans-α-farnesene), trans-3,7-dimethyl-1,3,6-octatriene (trans-β-ocimene), and (Z)-3,7-dimethyl-1,3,6-octatriene (cis-β-ocimene). Commonly, the hydrocarbyl, trisubstituted ethylene-containing moieties arise from copolymerisation of any one or a combination of β-myrcene, trans-β-farnesene, trans-β-ocimene or cis-β-ocimene. Sometimes, the hydrocarbyl, trisubstituted ethylene-containing moieties arise from copolymerisation of any one or a combination of monoterpenes. Often, the hydrocarbyl, trisubstituted ethylene-containing moieties arise from copolymerisation of only one of β-myrcene, trans-β-farnesene, trans-β-ocimene or cis-β-ocimene. Typically, the hydrocarbyl, trisubstituted ethylene-containing moieties arise from copolymerisation of any one or a combination of β-myrcene or trans-β-farnesene. Most typically, the hydrocarbyl, trisubstituted ethylene-containing moieties arise from copolymerisation of only any one of β-myrcene or trans-β-farnesene. Preferably, the hydrocarbyl, trisubstituted ethylene-containing moieties arise from copolymerisation of β-myrcene.

Myrcene, trans-β-farnesene, trans-β-ocimene or cis-β-ocimene are terpenes, which are synthesised in nature by the combination of isoprene subunits. These subunits come from the two isoprene phosphate isomers: isopentenyl pyrophosphate and dimethylallyl pyrophosphate. Myrcene, trans-β-farnesene, trans-β-ocimene and cis-β-ocimene are bio-based monomers, which can be extracted from renewable resources, and may, advantageously in accordance with the present invention, be used to replace non-renewable monomers for use in commercial rubbers.

Typically, the first copolymer of the first aspect of the invention is a terpolymer, wherein at least one, and typically just one, of the three different monomers gives rise to the hydrocarbyl, trisubstituted ethylene-containing moieties.

The first copolymer is commonly a copolymer of myrcene, trans-β-farnesene, trans-β-ocimene and/or cis-β-ocimene. Typically, the first copolymer is a copolymer of myrcene or trans-β-farnesene.

Sometimes the first copolymer is a copolymer of butadiene, styrene optionally substituted at one or more positions with a C₁-C₆ aliphatic or aromatic hydrocarbyl, isoprene, and/or 2,3-dimethyl-1,3-butadiene, and/or 2-methyl-1,2-pentadiene. Often, the C₁-C₆ aliphatic hydrocarbyl is saturated. The skilled person appreciates that such copolymers are made from at least one additional type of comonomer, which gives rise to the hydrocarbyl, trisubstituted ethylene-containing moieties, for example β-myrcene or trans-β-farnesene.

The styrene optionally substituted at one or more positions with a C₁-C₆ aliphatic or aromatic hydrocarbyl is typically selected from any one from, or a combination of, the group consisting of styrene, 4-methylstyrene, α-methylstyrene, para,α-dimethylstyrene, 1,1-diphenylethylene, 3-methylstyrene, 2-methylstyrene, 2,5-dimethylstyrene, 2,4-dimethylstyrene, 2,4,6-trimethylstyrene, 4-tert-butylstyrene, and/or 1-isopropenyl-3-methylbenzene. Typically, the styrene optionally substituted at one or more positions with a C₁-C₆ aliphatic or aromatic hydrocarbyl is selected from only one of this group.

Often, the styrene optionally substituted at one or more positions with a C₁-C₆ aliphatic or aromatic hydrocarbyl of the fourth aspect is styrene, 4-methylstyrene, α-methylstyrene, para,α-dimethylstyrene, and/or 1,1-diphenylethylene. The styrene is commonly unsubstituted.

Often, the first copolymer is a copolymer of butadiene, typically a copolymer of butadiene, styrene and/or isoprene, and often a copolymer of butadiene and/or styrene. The first copolymer is commonly a copolymer of butadiene and styrene. Typically, the first copolymer is a copolymer of myrcene, trans-β-farnesene, trans-β-ocimene or cis-β-ocimene, and is thus commonly a copolymer of butadiene, styrene and myrcene, butadiene, styrene and trans-β-farnesene, butadiene, styrene and trans-β-ocimene, or butadiene, styrene and cis-β-ocimene. Typically, the first copolymer is a copolymer of butadiene, styrene and myrcene.

Sometimes, the first copolymer is derived from comonomers comprising less than 10 or 5 mol % of the monomers providing the pendant hydrocarbyl, trisubstituted ethylene-containing moieties and typically less than 5 mol % myrcene. Often, the first copolymer is derived from comonomers comprising less than 10 or 5 mol % of myrcene, trans-β-farnesene, trans-β-ocimene and cis-β-ocimene.

According to particular embodiments, the first copolymer described herein consists essentially of butadiene, styrene and myrcene. By this is meant, for example, that the presence of additional components within the copolymer is permitted, provided the amounts of such additional components do not materially affect, in a detrimental manner, the essential characteristics of the copolymer. Given that the intention behind including the butadiene, styrene and myrcene in the first copolymer is to produce a rubber with properties suitable for use in articles, particularly those likely to be subject to a degree of wear (e.g. tyres), it will be understood that the inclusion of components that materially affect, in a detrimental manner, the tensile properties of the rubber, are excluded from the first copolymer. On the other hand, it will be understood that the presence of any components that do not materially affect, in a detrimental manner, the essential characteristics of the first copolymer, is included.

The first copolymer of the first aspect of the invention is a block and/or tapered block copolymer derived from at least three different types of monomer. Typically, the block and/or tapered block copolymer is derived from three monomers, one of which is myrcene, trans-β-farnesene, trans-β-ocimene or cis-β-ocimene. Often, the first copolymer is a triblock or a diblock copolymer. Sometimes, the first copolymer is a triblock or a diblock copolymer of styrene, butadiene and myrcene; styrene, butadiene and trans-β-farnesene; or styrene, butadiene and trans-β-ocimene. Often, the first copolymer is a triblock or diblock copolymer of styrene, butadiene and myrcene. When the first copolymer is a diblock copolymer of styrene, butadiene and myrcene, it often comprises a block of myrcene and a second block of styrene and butadiene. Often the block and/or tapered block copolymer is derived from comonomers comprising less than 10 mol % myrcene, trans-β-farnesene, trans-β-ocimene and cis-β-ocimene, and typically less than 5 mol %.

Often, the pendant hydrocarbyl, trisubstituted ethylene-containing moieties of the first copolymer are in a block or a tapered block, situated at one end of the copolymer chain. A block containing the pendant hydrocarbyl, trisubstituted ethylene-containing moieties may be formed by sequential polymerisation of monomers that, when polymerised, give rise to pendant hydrocarbyl, trisubstituted ethylene-containing moieties. Thus the first copolymer can be prepared by initially synthesising a block containing pendant hydrocarbyl, trisubstituted ethylene-containing moieties (e.g. via initiation), and then subsequently adding monomers that cannot give rise to pendant hydrocarbyl, trisubstituted ethylene-containing moieties. Alternatively, a block containing pendant hydrocarbyl, trisubstituted ethylene-containing moieties could be formed after complete consumption of monomers that cannot give rise to pendant hydrocarbyl, trisubstituted ethylene-containing moieties. Thus, the first copolymer can be prepared by initially polymerising monomer units that cannot give rise to pendant hydrocarbyl, trisubstituted ethylene-containing moieties and then subsequently adding monomer units that, when polymerised, give rise to pendant hydrocarbyl, trisubstituted ethylene-containing moieties.

The inventors have unexpectedly found that the formation of a tapered block containing the pendant hydrocarbyl, trisubstituted ethylene-containing moieties may be formed by forming the first copolymer in the presence of a randomiser and at least one monomer which gives rise to the pendant hydrocarbyl, trisubstituted ethylene-containing moieties, together with at least two monomers which cannot give rise to pendant hydrocarbyl, trisubstituted ethylene-containing moieties. Without wishing to be bound by theory, it would appear that the formation of the tapered block occurs as a result of the reactivity of the comonomers that give rise to the pendant hydrocarbyl, trisubstituted ethylene-containing moieties being different to that of the other comonomers. According to particular embodiments, the at least two monomers which cannot give rise to pendant hydrocarbyl, trisubstituted ethylene-containing moieties are styrene and butadiene.

Such tapered block copolymers may be formed via living anionic polymerisation, wherein the anionic polymerisation is conducted in the presence of a randomising agent. This results in greater incorporation of the monomers containing pendant hydrocarbyl, trisubstituted ethylene-containing moieties during the latter stages of the living anionic polymerisation. In this way, a tapered block copolymer is provided, in which there is a gradient distribution of polymerised monomers with pendant hydrocarbyl, trisubstituted ethylene-containing moieties along the length of the chains.

In particular embodiments, the first copolymer is linear. When the first copolymer is linear, it has two ends.

Sometimes the pendant hydrocarbyl, trisubstituted ethylene-containing moieties of the first copolymer are in two blocks, with one situated at each end of the copolymer chain. Thus the first copolymer can be prepared by initially synthesising a block containing pendant hydrocarbyl, trisubstituted ethylene-containing moieties, then adding monomers that cannot give rise to pendant hydrocarbyl, trisubstituted ethylene-containing moieties, and then adding monomer units that, when polymerised, give rise to pendant hydrocarbyl, trisubstituted ethylene-containing moieties. Monomer units that, when polymerised, cannot give rise to pendant hydrocarbyl, trisubstituted ethylene-containing moieties are often added in the presence of a randomiser such that these monomer units form a block of randomly distributed monomer units.

Sometimes, the pendant hydrocarbyl, trisubstituted ethylene-containing moieties are in a block situated at one end of the copolymer, and a tapered block situated at the other end. Thus, the first copolymer can be prepared by initially synthesising a block containing pendant hydrocarbyl, trisubstituted ethylene-containing moieties, and then subsequently adding a selection of at least one monomer which gives rise to the pendant hydrocarbyl, trisubstituted ethylene-containing moieties, together with at least two monomers which cannot give rise to pendant hydrocarbyl, trisubstituted ethylene-containing moieties.

Another method to prepare the first copolymer, wherein the pendant hydrocarbyl, trisubstituted ethylene-containing moieties of the first copolymer are in two blocks, includes initially synthesising two polymer chains comprising a block containing pendant hydrocarbyl, trisubstituted ethylene-containing moieties, then adding monomers that cannot give rise to pendant hydrocarbyl, trisubstituted ethylene-containing moieties, and then adding a difunctional coupling agent to couple two chains together. Alternatively, the first copolymer could be prepared by using a difunctional initiator and adding polymerising monomer units which cannot give rise to pendant hydrocarbyl, trisubstituted ethylene-containing moieties, and then subsequently adding monomer units which, when polymerised, give rise to pendant hydrocarbyl, trisubstituted ethylene-containing moieties. A similar method may also be used to prepare the first copolymer wherein the pendant hydrocarbyl, trisubstituted ethylene-containing moieties of the first copolymer are in two tapered blocks: a difunctional initiator could be used, to which a selection of at least one monomer which gives rise to the pendant hydrocarbyl, trisubstituted ethylene-containing moieties, together with at least two monomers which cannot give rise to pendant hydrocarbyl, trisubstituted ethylene-containing moieties, is added.

Still other methods that may be used to prepare the first copolymer are well known to the skilled person.

In these methods, the resultant copolymer comprises a block and/or tapered block of pendant hydrocarbyl, trisubstituted ethylene-containing moieties at one end or both ends of the copolymer chain. Typically, the block and/or tapered block is derived from myrcene, trans-β-farnesene, trans-R-ocimene and/or cis-β-ocimene monomers. Often, the block copolymer is derived from comonomers comprising less than 10 mol % myrcene, trans-β-farnesene, trans-β-ocimene and cis-β-ocimene, and typically less than 5 mol %. Often, the resultant copolymer comprises a block and/or tapered block of myrcene comonomers at one or both ends of the copolymer chain and a block of randomly distributed styrene and butadiene.

Oxidants for use in effecting the epoxidation reaction in the first aspect of the invention include any oxidant suitable for epoxidation of a trisubstituted ethylene-containing moiety. Typically, the oxidant is a peroxy acid (as in the Prilezhaev reaction). The term “peroxy acid” may be used interchangeably with the term “peracid”. Other suitable oxidants include a Mn-salen catalyst used with a stoichiometric amount of bleach, e.g. NaOCl, (as in Jacobsen or Jacobsen-Katsuki epoxidation, see E. N. Jacobsen et al., J. Am. Chem. Soc., 1991, 113, 7063-7064), a Ti(OiPr)₄ catalyst used with tert-butyl hydroperoxide (as in Sharpless epoxidation, see T. Katsuki and K. B. Sharpless, J. Am. Chem. Soc., 1980, 102(18), 5974), and a fructose-derived organocatalyst used with oxone (as in Shi epoxidation, see Z-X. Wang et al., J. Am. Chem. Soc., 1997, 119, 11224-11235).

Typically, the epoxidation reaction of the first aspect of the invention and/or any one of the previous embodiments, is effected by reacting the first copolymer with a peroxy acid.

Suitable peroxy acids for the method of the invention include 3-chloroperbenzoic acid (also known as meta-chloroperbenzoic acid, m-CPBA), peracetic acid, trifluoroacetic peracid, peroxybenzimidic acid (known as Payne's reagent) and magnesium monoperoxyphthalate.

Typically, the peroxy acid is 3-chloroperbenzoic acid (m-CPBA) (see R. Pandit et al., Macromolecular Symposia, 2014, 341(1), 67-74).

Generally, the amount of oxidant used is that required to epoxidise 95-110%, for example 100-105%, of the theoretical amount of pendant trisubstituted ethylene-containing moieties present in the first copolymer.

The skilled person is aware of reaction conditions suitable for use in epoxidation reactions. Typically, epoxidation is carried out under an inert atmosphere, comprising, for example, argon or nitrogen, at temperatures of 25° C. or lower, often 0° C. or lower (for example −10° C.), although higher temperatures, for example between about 20° C. and about 70° C. may be useful. Typical reaction times vary between about 2 and about 24 hours. Reactions are typically conducted in an aprotic solvent or mixture of aprotic solvents. The aprotic solvent can, for example, be one or more aprotic solvents, for example selected from the group consisting of dichloromethane (DCM), THF, acetonitrile and hydrocarbon solvents such as hexanes or cyclohexane.

The first copolymer can be prepared by living anionic polymerisation, i.e. the first aspect of the invention may further comprise preparing the first copolymer by living anionic polymerisation.

The skilled person is aware that the term “living polymerisation” refers to polymerisation in which:

(i) polymerisation continues as long as a monomer is present, thus if additional monomer is added to a reaction in which polymerisation has ceased, the polymerisation will proceed once more;
(ii) the number average molecular weight (Mₙ) of the polymer that results and the number average degree of polymerisation (Xₙ) are directly proportional to monomer conversion;
(iii) the number of propagating chains is independent of the conversion and thus is constant throughout the reaction;
(iv) the Mₙ of the final polymer can be controlled by the initial molar ratios of monomer and initiator;
(v) polymers with a low dispersity (<1.1) are synthesised;
(vi) block copolymers can be synthesised through the sequential addition of different monomers once the previous block has been polymerised; and
(vii) chain-end functionalisation can be achieved in quantitative yield through controlled termination reactions (see H. L. Hsieh and R. P. Quirk, Supra).

Any copolymers prepared by living-anionic polymerisation that are compatible with the epoxidation reaction described herein may be used. Functionality other than that introduced by epoxidation of the copolymer may be desirable. Therefore, it may be of benefit to use copolymers that are functionalised at sites that exclude the pendant hydrocarbyl, trisubstituted ethylene-containing moieties. These sites may be within the polymer chain or at either or both ends of the polymer chain. The copolymer may be in-chain and/or end-chain functionalised through the use of functionalised initiators, terminators and/or monomers. The introduction of functional groups at the w-chain end (this term denoting the termination end of a copolymer via termination reactions) has been widely reported. This may be achieved by termination of polymerisation by reaction with electrophilic groups, including alkyl halides, silyl halides, carbon dioxide and ethylene oxide. End-capping with functionalised derivatives of diphenylethylene has also been widely reported.

The opposite approach to the introduction of functional groups at the w-chain end is the introduction of functional groups at the α-chain end (at which polymerisation is initiated), whereby to achieve end-functionalisation via initiation. This is achieved by the use of functionalised initiators. The approach can be advantageous since it allows access to the introduction of functionality at both chain ends (if functionalisation is also introduced by terminating reactions) and allows the synthesis of branched polymers with functional chain-ends. However there are far fewer reported examples of achieving functionalisation in this way.

To be compatible with living anionic polymerisation, the functionalised initiators, terminators and/or monomers are typically protected by protecting groups. The nature of the protecting groups is not particularly limited with the proviso that the protecting group is stable under the conditions experienced in living anionic polymerisation reactions. The presence of unprotected electron-deficient, polar functional groups is to be avoided, as this would otherwise cause termination of the propagating steps during polymerisation. However, it is equally required that the protecting groups may be removed from the α-end of the resultant polymer, whereby to reveal its intrinsic functionality, after completion of the living anionic polymerisation, without destroying the polymer.

The term “protecting group”, used synonymously in the art with the term “protective group”, presents no interpretative difficulty to the skilled person. It is defined in the first paragraph of Chapter 1 of the very well-known textbook “Greene's Protective Groups in Organic Synthesis” (5^{th} Edition P. G. M Wuts, Wiley, 2014) as follows:

“A protective group must fulfil a number of requirements. It must react selectively in good yield to give a protected substrate that is stable to the projected reactions. The protective group must be selectively removed in good yield by readily available, preferably nontoxic reagents that do not attack the regenerated functional group. The protective group should form a derivative (without the generation of new stereogenic centers) that can easily be separated from side products associated with its formation or cleavage. The protective group should have a minimum of additional functionality to avoid further sites of reaction. All things considered, no protective group is the best protective group”.

Accordingly, it is clear from this seminal text that appropriate protecting groups may be selected amongst other things with regard to projected reaction conditions. According to the present invention, these projected reaction conditions are those under which living anionic polymerisations may be effected. Such conditions are well understood by the skilled person (see, for example, H. L. Hsieh & R. P. Quirk, Supra; and M Morton, Anionic Polymerization: Principle and Practice, Elsevier Academic Press, New York, 1983). For example, it is known that the reactivity of the propagating anion in living anionic polymerisations may act as both a strong base and a strong nucleophile (vide supra). Accordingly, protecting groups used in accordance with the present invention must be stable under such conditions. The skilled person can determine without undue burden appropriate protecting groups for use with living anionic polymerisations in particular with reference to the detailed guidance provided in Greene's Protective Groups in Organic Synthesis. Accordingly, the skilled person is quite capable of determining the metes and bounds of protecting groups that are stable under conditions for living anionic polymerisation reactions.

The skilled person will understand that no two protecting groups will require the same conditions for introduction into a molecule. Likewise, no two protecting groups will require the same conditions for deprotection from a molecule. For example tert-butyldimethylsilyl (TBDMS) is generally regarded as a more robust protecting group than trimethylsilyl (TMS). This means that it is more stable during polymerisation reactions but also that harsher conditions are generally necessary to effect its deprotection after use. Nevertheless, both these (and other silyl) protecting groups are suitable for use during anionic living polymerisation reactions and may be selectively removed post-polymerisation.

Depending on which functional groups are present, it may be preferred to retain the protecting group or to replace it with another protecting group for the epoxidation reaction of the first aspect of the invention. Any functional groups that are incompatible with the conditions experienced in epoxidation should be protected, for example ketones, acyl halides and sulfides. The skilled person can determine without undue burden which functional groups to protect and which protecting groups are appropriate for use with epoxidation reactions. Generally, the first copolymer does not comprise any functional groups that are incompatible with the epoxidation reaction of the first aspect of the invention. Thus, often the first copolymer does not comprise any protected functional groups. Typically, functionality of the polymer is achieved via the epoxidation and optional ring-opening reactions described herein.

Anionic polymerisation reactions are well-known to those of skill in the art (see H. L. Hsieh and R. P. Quirk, Supra), and reference is made to the description of examples of polymerisation reactions in the experimental section below, involving the polymerisation of myrcene and the copolymerisation of myrcene and butadiene, myrcene and styrene, and myrcene, butadiene and styrene, as well as the standard texts concerning anionic polymerisation referred to herein.

As is known, in the case of vinyl carbanionic polymerisation, the initiation and propagation steps in living anionic polymerisations involve successive nucleophilic additions to double bonds of the reactant (co)monomers. Although the skilled person is well acquainted with such issues, a number of fundamental requirements of such polymerisations are worth mentioning briefly, in connection with the polymerisation of such vinyl (i.e. C═C— containing) monomers to be polymerised according to such methods. Firstly, the C═C bond has to be the most electrophilic functionality present: the presence of other reactive electrophilic sites may lead to unwanted side-reactions. Thus even mildly acidic proton-donating groups (e.g. amino, hydroxyl, carboxyl, and acetylene) or strongly electrophilic functional groups (e.g. cyano, nitro and sulfonyl) which may react with bases and nucleophiles should be protected or avoided. In addition, the presence of electron-withdrawing groups as substituents on the C═C bond can sometimes be advantageous to activate the double bond and thereby enhance its electrophilic character. Examples of such substituents are the vinyl group in (and which may be regarded as a substituent of ethylene forming) 1,4-butadiene, as well as the phenyl group in styrene.

Anionic polymerisation may be initiated using any initiator suitable for use in living anionic polymerisation reactions. Reagents commonly used to initiate anionic polymerisation are butyl lithium reagents, typically any one or a combination of n-butyl lithium, sec-butyl lithium, and tert-butyl lithium. The skilled person is aware that sec-butyl lithium may be abbreviated to sec-BuLi or ⁵BuLi and has two stereoisomers, but is commonly used as a racemate. Often, the butyl lithium initiator is n-butyl lithium.

The nature of the carbanion resulting from the addition of a monomer to a growing polymer chain also merits consideration. In general vinyl monomers are susceptible to anionic polymerisation because the negative charge on the carbanion is stabilised by anionic charge delocalisation, owing to its substituent. Finally the carbanion has to be nucleophilic and reactive enough to further propagate the reaction.

Because of the high basicity and nucleophilicity of the initiating and propagating groups present in anionic polymerisations, solvents most commonly used for anionic polymerisation tend to be limited to aprotic solvents: for example aliphatic and aromatic hydrocarbons and ethers such as THF and diethyl ether. Commonly, anionic polymerisation is carried out in a non-polar aprotic solvent comprising any one or a combination of benzene, toluene, cyclohexane, hexane and heptane. Typically, the non-polar aprotic solvent is cyclohexane or toluene.

The skilled person is aware that epoxidation of the first copolymer, described herein, via the epoxidation may be carried out at any appropriate time, i.e. the first copolymer, described herein, may be stored under suitable conditions for a period of time prior to epoxidation. The skilled person is aware of the stability of the first copolymer described herein and is able to assess how long and under what conditions the first copolymer may be stored before it is epoxidised. If necessary, the first copolymer may be stored at low temperatures, for example in a fridge or freezer and/or may be stored in an inert atmosphere (for example, under nitrogen or argon).

Commonly, at least a part of the anionic polymerisation suitable for preparation of the first copolymer is conducted in the presence of a randomising agent. The method of the third aspect of the invention comprises preparation of a first copolymer via anionic polymerisation conducted in the presence of a randomising agent.

Examples of polar compounds that can be employed as randomisers in living anionic polymerisation are given in EP 0673953 A1 (Phillips Petroleum Company), US 2016/369063 (Matmour et al), EP 1510551 (BASF Atiengesellschaft), and H. L. Hsieh & R. P. Quirk (supra), and include ethers, thioethers, metal alkoxides and amines. Commonly used randomisers for the anionic copolymerisations, for example of styrene and butadiene, include ethers such as DTHFP, amines such as (TMEDA) and potassium butoxide.

Commonly, the randomising agent is selected from any one, or a combination of the group consisting of TMEDA, DTHFP and tetrahydrofuryl ethyl ether (THFEE). Typically, the randomising agent is TMEDA.

TMEDA can be used to randomise the position of monomers in the first copolymer, for example when the first copolymer is poly(butadiene-co-styrene), TMEDA can be used to randomise the positions of butadiene and styrene in the copolymer chain. Without being bound by theory, the randomiser (for example, TMEDA) is able to chelate to the counterion stabilising the propagating chain end (typically lithium) and the resulting change in the bond length/strength of the bond between the counterion and the carbon at the end of the propagating chain randomises the incorporation of the two monomers.

DTHFP may be used to randomise the position of monomers in the first copolymer. The final step in the synthesis commonly used to prepare DTHFP involves the catalytic hydrogenation of the bis-furan, which results in the formation of two chiral centres and three stereoisomers (see scheme (1) below).

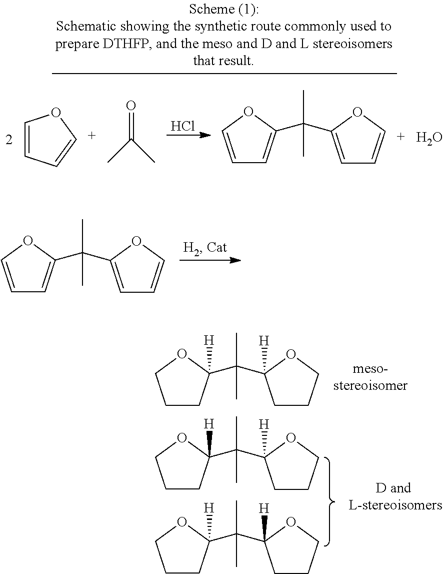

It has been shown by T. E. Hogan, W. Kiridena and L. Kocsis in Rubber Chem. Technol., 2017, 90(2), 325-336 that DTHFP is effective in randomising the incorporation of styrene monomers on copolymerising styrene with butadiene. It was found that the styrene residues are randomised to the same extent when either meso-DTHFP or a combination of D- and L-DTHFP are used.

It was also found that the meso stereoisomer of DTHFP is more effective than the D- and L-stereoisomers in incorporating 1,2-butadienyl residues into butadiene polymers and copolymers. Randomisers may be used to favour incorporation of 1,2-butadienyl residues over 1,4-butadienyl residues by increasing the rate of polymerisation. At faster polymerisation rates, the kinetic product (1,2-butadienyl) is preferred over the thermodynamic product (1,4-butadienyl), thus a greater 1,2-butadienyl content results. However, it is shown by Hogan et al. that when meso-DTHFP or D- and L-DTHFP are employed, polymerisation proceeds at a similar rate. It is hypothesised that the non-bonding electrons on the two oxygen atoms in the meso DTHFP are oriented such that orbital overlap into the empty orbitals of the counterion stabilising the propagating chain end (in this case a lithium cation) is better than that attained with the D- and L-DTHFP. Without being bound by theory, it is hypothesised that the stronger coordination of meso-DTHFP to the lithium counterion favours incorporation of 1,2-butadienyl residues into the propagating chain.

The randomising agent may be added to the polymerisation reaction at any stage of copolymerisation, allowing flexibility in the structures of the copolymers that form. For example, the first copolymer can be prepared by living anionic polymerisation, wherein the entire anionic polymerisation is conducted in the presence of a randomising agent, i.e. the randomising agent is present when polymerisation of the comonomers is initiated, resulting in randomisation and/or tapering of comonomer distribution throughout the copolymer. Alternatively, the first copolymer can be prepared by living anionic polymerisation, wherein a part of the anionic polymerisation (typically after initiation) is conducted in the presence of a randomising agent, i.e. the randomising agent may be added at a certain stage of anionic polymerisation, after polymerisation has initiated, thereby allowing a block containing an initial ratio of comonomers to form first, followed by addition of the randomiser to form a tapered block containing a different ratio/gradient of comonomers. Selection of randomiser, the amount employed, and the time of addition of the randomising agent can be used to manipulate the degree and direction of taper in the tapered block.

The anionic polymerisation may be terminated with ω-functionalising moieties, terminating reactions with which the skilled person is familiar. See, for example, H. L. Hsieh & R. P. Quirk (supra). ω-Termination allows access to both α- and ω-functionalised polymers, enhancing further the control that may be exerted over the functionalised polymers that may be prepared in accordance with the present invention. The skilled person is well aware of methods of effecting ω-termination

As a particular type of ω-termination, specific reference may be made to termination with, for example, multifunctional silyl halides, in particular silyl chlorides (chlorosilanes), since this type of ω-termination permits access to star-branched polymers and block copolymers.

Conceptually, there are two ways to prepare star-branched polymers: the “core first” approach where a number of arms are grown simultaneously from a multifunctional initiator; and the “arm first” approach where pre-prepared arms are coupled to a multifunctional coupling agent, with termination of polymerisation proceeding via a multifunctional halosilane (for example a chlorosilane such as methyltrichlorosilane for a three-armed star or tetrachlorosilane for a four-armed star). The provision of star-branched polymers is increasingly sought in tyre tread rubber because of their beneficial rheological (processing) properties.

Often, the anionic polymerisation comprises a terminating step involving introducing a halosilane into the anionic polymerisation reaction. Typically, the halosilane is a chlorosilane, commonly methyltrichlorosilane and/or tetrachlorosilane. Typically, the halosilane is methyltrichlorosilane or tetrachlorosilane.

Alternatively, the anionic polymerisation comprises a terminating step involving introduction of a proton donor, for example a carboxylic acid such as acetic acid or an alcohol. Commonly, the alcohol is selected from any one or a combination of methanol, ethanol, isopropanol, butanol and pentanol. Typically, the alcohol is selected from any one or a combination of methanol, ethanol or isopropanol. The alcohol is commonly methanol.

The method of the first aspect of the invention may further comprise reacting at least some of the epoxide groups of the second copolymer with a nucleophile to provide a third copolymer. This reacting involves the ring-opening of the epoxide group.

Ring-opening of at least some of the epoxide groups of the second copolymer may be carried out at any appropriate time, i.e. the second copolymer may be stored under suitable conditions for a period of time prior to the ring-opening reaction. The skilled person is aware of the stability of the second copolymer described herein and is able to assess how long and under what conditions the second copolymer may be stored before ring-opening. If necessary, the second copolymer may be stored at low temperatures (for example in a fridge or freezer) and/or may be stored in an inert atmosphere (for example, under nitrogen or argon).

Epoxide ring-opening reactions including details of how to carry them out are well-known to those of skill in the art. Also, reference is made to the description of examples of ring-opening reactions in the experimental section below, involving ring-opening using a water nucleophile or a sodium azide nucleophile.

Any functional groups present in the second copolymer that are incompatible with the conditions experienced in ring-opening of epoxides should be protected. This includes any functional groups that are susceptible to nucleophilic attack, for example halides and carbonyl groups including ketones, aldehydes, carboxylic acids, and acyl halides. It may be preferred to retain any protecting groups present in the second copolymer, or to replace them with other protecting groups. The skilled person can determine without undue burden which functional groups to protect and which protecting groups are appropriate for use with epoxide ring-opening reactions. Generally, the second copolymer does not comprise any functional groups that are incompatible with the epoxide ring-opening reaction of the first aspect of the invention. Thus, often the second copolymer does not comprise any protected functional groups.

Nucleophiles for use in the epoxide ring-opening reaction described herein include any nucleophile suitable for reaction with a trisubstituted epoxy-containing moiety. The three-membered ring of an epoxide is highly strained, which typically results in good reactivity with nucleophiles, which ring-open the epoxide to form a functionalised alcohol. Therefore, epoxides are useful as precursors to a wide variety of other functional groups. Common nucleophiles used to ring-open epoxides include water, azides, amines, hydroxides, cyano groups, alkoxides, alcohols, sulfides, thioalkyls, thiols, sulfoxides, sulfites, Grignard reagents, organolithium reagents, and hydrohalic acids (for a review on epoxide reactivity, see A. Padwa and S. Shaun Murphree, ARKIVOC, 2006, (iii), 6-33). Hydrides are also commonly used to ring-open epoxides, and may, for example, be provided by any one of the group consisting of lithium aluminium hydride, sodium hydride, potassium hydride, diisobutylaluminium hydride, sodium borohydride, lithium borohydride and potassium borohydride.

When using weaker nucleophiles, for example water, azides, amines, alcohols and thiols, ring-opening of the epoxide typically requires the addition of an acid catalyst. The acid catalyst increases the electrophilicity of the epoxide, thus making it more receptive to nucleophilic attack. Methods to promote ring-opening of epoxides, are well known in the art and may be applied to the ring-opening reaction of the present invention. Well-known techniques used to promote reactions in general include increasing the energy supplied to the reaction mixture (for example by heating, microwaving or sonicating the reaction mixture), and increasing the reaction time, i.e. the time that the reactants are in contact. All of these techniques may be used to promote the ring-opening reaction of the epoxides of the second copolymer, as well as the epoxidation of the first copolymer. The skilled person is able to assess which temperatures and pressures are appropriate to use with the reagents and solvents employed by considering, for example, the boiling point, the polarity and the dielectric properties. Typically, epoxide ring-opening reactions are carried out at temperatures of 90 to 110° C. with a solvent selected from any one or a mixture of benzene, toluene, cyclohexane, hexane, heptane and dioxane. Sometimes, epoxide ring-opening reactions are carried out under an inert atmosphere, comprising, for example, argon or nitrogen. Normal atmospheric pressures are typically suitable and reaction times may be 0.1 to 72 hours, typically 0.25 to 48 hours.

Where the nucleophile is an azide group, this can in turn can be used in “click” coupling reactions, or reduced to synthesise an amine group. Introduction of an azide group can be tuned through the variation of the experimental conditions such as the pH, or through the addition of different ionic salts to change both the stereoselectivity and regioselectivity of the attack (see A. Padwa and S. Shaun Murphree (supra)).

Often, the nucleophile is selected from the group consisting of hydrides, water, azides, amines, and hydroxides.

Typically, the nucleophile is selected from the group consisting of water, azides, amines, and hydroxides. Typically, the nucleophile is water or sodium azide.

Alternatively, the nucleophile is a hydride, often provided by any one of the group consisting of lithium aluminium hydride, sodium hydride, potassium hydride, diisobutylaluminium hydride, sodium borohydride, lithium borohydride and potassium borohydride. Hydrides provided by borohydrides are often effective in ring-opening unsubstituted epoxide groups, with the general formula —HCOCH—. Where the epoxide group is substituted at either or both carbon atoms, stronger nucleophiles, such as hydrides provided by lithium aluminium hydride, sodium hydride, potassium hydride or diisobutylaluminium hydride, are typically required to ring-open the epoxide group. Typically, the hydride is provided by any one of the group consisting of lithium aluminium hydride, sodium hydride, potassium hydride and diisobutylaluminium hydride. Most typically, the hydride is provided by lithium aluminium hydride.

When the nucleophile is a hydride, the reaction is typically quenched with a proton donor. The proton donor may react with residual hydride in the reaction mixture and/or may protonate an alkoxide (produced when ring-opening at least some of the epoxide groups). The skilled person is aware that small quantities of residual hydride may be safely quenched by the careful addition of alcohols such as methanol, ethanol or isopropanol.

Successful protonation of an alkoxide (produced when ring-opening at least some of the epoxide groups) requires a pKa which is lower than that of simple primary alcohols, such as a pKa of less than about 15.5 or a pKa of about −1 to about 15.5. For example, the skilled person is aware that strong mineral acids, such as HCl or H₂SO₄, may be used to protonate the alkoxide but that care may be needed as reaction of the acid with residual hydride may be very rapid and is likely to be exothermic. The skilled person is aware of measures that may be used to control the reaction rate. For example, the acid may be diluted in water and may need to be added to the reaction drop-wise and at low temperatures, for example at about −78° C. to about 0° C. Preferably, the hydride should be quenched by the careful addition of an alcohol prior to the addition of a proton donor with a pKa lower than that of simple primary alcohols to protonate the alkoxide.

The proton donor often has a pKa of about −1 to about 10, about 1 to about 8, or about 3 to about 6. Typically, the proton donor has a pKa of about 3 to about 6, such as about 4 to about 5. It is to be understood that the pKa values refer to the pKa of the proton donor in water.

Often, the proton donor is any one or a combination selected from the group consisting of acetic acid, benzoic acid, ascorbic acid, formic acid, citric acid, oxalic acid, trichloroacetic acid and trifluoroacetic acid. Typically, the proton donor is any one or a combination selected from the group consisting of acetic acid, benzoic acid, ascorbic acid, formic acid, citric acid and oxalic acid. Most typically, the proton donor is acetic acid.

Often, depending on the comonomers and the reaction conditions, the reacting of the nucleophile with at least some of the epoxide groups of the second copolymer is carried out in the presence of acid. However, it is to be understood that, when the nucleophile is a hydride, the reacting of the nucleophile with at least some of the epoxide groups of the second copolymer is not carried out in the presence of acid.

When the reacting of the nucleophile with at least some of the epoxide groups of the second copolymer is carried out in the presence of acid, the acid can be any acid suitable for catalysing the ring-opening of an epoxide via nucleophilic attack. The skilled person is aware of which acids are suitable for use with which nucleophiles. Suitable acids include any one or a combination of hydrochloric acid (HCl), acetic acid, triflic acid, sulphuric acid, nitric acid, citric acid, carbonic acid, phosphoric acid, oxalic acid, hydrobromic acid, hydroiodic acid, perchloric acid and chloric acid. Often, any one or a combination of hydrochloric acid, acetic acid and/or triflic acid is used. Typically, hydrochloric acid, acetic acid or triflic acid is used.

The copolymer of the second aspect of the invention is obtainable by the method of the first aspect of the invention. The term “obtainable” includes within its ambit the term “obtained”, i.e. the copolymer of the second aspect of the invention may be obtained by the method of the first aspect of the invention. The copolymer of the second aspect of the invention comprises epoxide groups (i.e. is a second copolymer as described herein), or is the product of reacting at least some of the epoxide groups with a nucleophile (i.e. is a third copolymer as described herein).

Included within the second aspect of the invention, is a copolymer comprising a backbone from which hydrocarbyl, trisubstituted epoxide-containing moieties are pendant. The position of such trisubstituted epoxide-containing moieties can be controlled, owing to selective epoxidation of the precursor trisubstituted ethylene-containing moieties over other ethylene moieties that may be, and typically are, present in the first copolymer (e.g. a first copolymer obtainable from copolymerisation of butadiene, isoprene, and/or monomers that provide the trisubstituted ethylene-containing moieties, such as myrcene). The skilled person is aware that “selective epoxidation” means that the precursor trisubstituted ethylene-containing moieties are more susceptible to epoxidation than other ethylene moieties.

A copolymer comprising a backbone from which hydrocarbyl, trisubstituted epoxide-containing moieties are pendant and are distributed in a tapered block also lies within the scope of the second aspect of the invention. Often, the number of hydrocarbyl, trisubstituted epoxide-containing moieties increases from the initiating to the terminal end of the copolymer. Thus, there may be a higher number of the hydrocarbyl, trisubstituted epoxide-containing moieties at the terminal end than at the initiating end of the copolymer. Often, the hydrocarbyl, trisubstituted epoxide-containing moieties are clustered in a block or tapered block at the terminal end. As such block and/or tapered block copolymers are included within the second aspect of the invention, the relevant embodiments of the second and first aspects of the invention as defined herein apply. For example, the pendant hydrocarbyl, trisubstituted epoxide-containing moieties (which arise from selective epoxidation of pendant hydrocarbyl, trisubstituted ethylene-containing moieties) may be derived from a terpolymer, and the terpolymer may be a block and/or tapered block copolymer of butadiene, styrene and myrcene.

The term “initiating end” refers to the chain end of a copolymer at which anionic polymerisation was initiated, i.e. the chain end at which initiation took place, and from which the copolymer chain grew.

The term “terminal end” refers to the chain end of a copolymer at which anionic polymerisation was terminated, i.e. the chain end at which termination took place and polymer growth ended.

Furthermore, a copolymer comprising a backbone from which moieties containing a substituted ethane of formula RR′(X′)C—C(X)R″H, wherein two of the R, R′ and R″ are hydrocarbyl groups and the other is a hydrocarbylene group connecting the ethylene moiety to the copolymer backbone, and X and X′ are both OH or one is OH and the other is N₃, also lies within the ambit of the second aspect of the invention. Such copolymers may be synthesised from reacting at least some of the epoxide groups in a copolymer comprising a backbone from which hydrocarbyl, trisubstituted epoxide-containing moieties are pendant with a nucleophile. Therefore, the position of such RR′(X′)C—C(X)R″H moieties is controllable by controlling the position of the tri-substituted ethylene-containing moieties. A copolymer comprising a backbone from which RR′(X′)C—C(X)R″H moieties are pendant and are distributed in a tapered block also lies within the scope of the invention. Preferably, the gradient within the tapered block correlates with the number of the RR′(X′)C—C(X)R″H moieties increasing from the initiating to the terminal end of the copolymer. Often, the RR′(X′)C—C(X)R″H moieties are clustered in a block or tapered block at the terminal end. As such copolymers are included within the ambit of the second aspect of the invention, the relevant embodiments of the second and first aspects of the invention apply. For example, the pendant RR′(X′)C—C(X)R″H moieties (which arise from ring-opening of the pendant hydrocarbyl, trisubstituted epoxide-containing moieties of the second copolymer, which in turn arise from selective epoxidation of pendant hydrocarbyl, trisubstituted ethylene-containing moieties of the first copolymer) may be derived from a block and/or tapered block copolymer of myrcene and/or trans-β-farnesene, or may be derived from a block and/or tapered block copolymer of butadiene, styrene and/or isoprene.

Typically, the copolymer of the second aspect of the invention is a third copolymer, as described herein, i.e. the copolymer is the product of reacting at least some of the epoxide groups of the second copolymer with a nucleophile.

Often, the copolymer of the second aspect of the invention is a solution styrene butadiene rubber (sSBR), i.e. a styrene butadiene rubber (SBR) prepared by anionic living polymerisation. Although the invention is discussed herein with particular reference to sSBR, and the copolymers of the invention are discussed herein as comprising architecture resulting from the presence of comonomers such as myrcene, with myrcene providing the pendant hydrocarbyl, trisubstituted ethylene-containing moieties, it is to be understood that the discussion of such embodiments is illustrative, rather than limitative, of the invention.

Often, polymers including polybutadiene, polyisoprene, styrene-butadiene rubber (SBR) and styrene-diene block copolymers are made using anionic polymerisation, in part because of the multiple ways in which control may be effected the resultant polymers such as their molecular weights, molecular weight distribution, copolymer composition, stereochemistry, and chain-end functionality (vide supra).

The present invention, although it is not to be understood to be so limited, is of particular utility in connection with the preparation of a specific class of copolymer—SBR—and the discussion herein focuses on the utility of the present invention in this regard. SBR is a class of random copolymers developed as one of the first classes of synthetic latex to compete with natural rubber. SBR is now the predominant synthetic rubber (by volume) in the world. It can be prepared in emulsion or in solution (labelled eSBR and sSBR respectively). sSBR is widely used in automobile and truck tyres. The improved wet grip and rolling resistance of sSBR rubber leads to advantageous safety and good fuel efficiency. sSBR rubber is also resistant to abrasion, has a low glass transition temperature and can undergo more elastic deformation under stress than other materials. All these characteristics make them able to meet the specifications of high-performance tyres.

eSBR is produced by radical polymerisation. In contrast, sSBR is produced by anionic polymerisation of styrene and butadiene, typically in hydrocarbon solvents and with the use of alkyllithium initiators and a randomiser. sSBR is increasingly favoured in the tyre industry in particular because of the overall control of the polymer's properties achievable through preparation using living anionic polymerisation.

The constituents of tyres and the general features of tyres and tyre manufacture in connection with which the present invention has particular utility, are well known. For example, it is known that tyres themselves are formed from multiple components. Prominent amongst these are the rubber and the so-called filler components. Two fillers—silica and carbon black—are particularly common in tyre manufacture and are often used in combination. The provision of α-functionalised sSBR in accordance with the present invention is of direct relevance here. The provision of appropriately functionalised polymers (i.e. with polar functionality) can be advantageous in improving the dispersibility and thus processability of the mixtures from which tyres are formed. For example, it is understood that when the functional groups at polymer chain ends bind with silica, the total number of exposed chain ends within the resultant system is lowered, thereby lowering hysteresis. Similar effects occur where a filler is or includes carbon black, it being understood in the art that this material has peripheral carbonyl functionality likewise capable of interacting with terminal hydroxy or amino functionality.

Generally, as the skilled person is aware, compositions for use in tyre manufacture comprise additional materials in addition to the rubber and filler components, for example vulcanisation agents and accelerators. In order to prepare a vulcanised sSBR-based tyre, typically, but not necessarily, the sSBR and filler components (and optionally additional components) are mixed, often with the application of heat, a process generally referred to in the art and herein as compounding. Generally, the resultant mixture is cooled and one or more vulcanisation agents and optionally vulcanisation accelerators are added before forming the resultant material into the shape of the desired ultimate article (e.g. a tyre) and vulcanising (which process typically involves heating to a temperature of between about 120° C. and about 200° C. Such information is well within the customary knowledge of the skilled person. For example, standard information pertaining to vulcanising agents may be found in Chapter 7 of the second edition of Rubber Compounding: Principles, Materials, and Techniques (Marcel Dekker, New York, 1993).

It is thus evident that the copolymers in accordance with the second aspect of the invention, i.e. the second and third copolymers, are of utility, particularly in embodiments in which the copolymer is sSBR. Such polymers may therefore be present in the curable compositions in accordance with the fifth aspect of the invention.

The copolymer of the fourth aspect of the invention is the first copolymer of the first aspect of the invention, obtainable by the anionic polymerisation method of the third aspect. The term “obtainable” includes within its ambit the term “obtained”, i.e. the copolymer of the fourth aspect of the invention may be obtained by the anionic polymerisation method described herein.

For the avoidance of doubt, the relevant embodiments of the first aspect of the invention that apply to the first copolymer, also apply to the copolymer of the fourth aspect of the invention. For example, the hydrocarbyl, trisubstituted ethylene-containing moieties of the copolymer of the fourth aspect of the invention may arise from a terpolymer and the terpolymer may comprise butadiene, styrene and myrcene.

The skilled person is aware that the copolymer of the fourth aspect of the invention is obtainable by the anionic polymerisation method of the third aspect of the invention, in which at least a part of the anionic polymerisation is conducted in the presence of a randomising agent. For the avoidance of doubt, the relevant embodiments of the first aspect of the invention also apply to the method of the third aspect of the invention. For example, the randomising agent used in the method of the third aspect of the invention may be N,N,N′,N′-tetramethylethylenediamine.

Also within the scope of the fourth aspect of the invention is a copolymer comprising a backbone from which hydrocarbyl, trisubstituted ethylene-containing moieties are pendant and are distributed in a tapered block. Preferably, the gradient within the tapered block correlates with the number of the hydrocarbyl, trisubstituted ethylene-containing moieties increasing from the initiating to the terminal end of the copolymer. Often, the hydrocarbyl, trisubstituted ethylene-containing moieties are clustered in a block or tapered block at the terminal end.

Living anionic polymerisation of comonomers conducted in the presence of a randomising agent, is expected to produce a random distribution of comonomers. However, this is surprisingly found not to be the case in the living anionic polymerisation of a copolymer of the third aspect of the invention, i.e. in which at least a part of the anionic polymerisation is conducted in the presence of a randomising agent. Whilst the monomers without pendant hydrocarbyl, trisubstituted ethylene-containing moieties are randomised, the monomers with pendant hydrocarbyl, trisubstituted ethylene-containing moieties are not randomly incorporated. Instead, the inventors surprisingly found that they are predominantly incorporated during the latter stages of the living anionic polymerisation. Thus, a tapered block of monomers with pendant hydrocarbyl, trisubstituted ethylene-containing moieties along the length of the chains formed, with the number of the hydrocarbyl, trisubstituted ethylene-containing moieties increasing from the initiating to the terminal end of the copolymer, i.e. the hydrocarbyl, trisubstituted ethylene-containing moieties are clustered in a block or tapered block at the terminal end. Thus, functionalisation of the pendant hydrocarbyl, trisubstituted ethylene-containing moieties (via, for example, epoxidation and/or ring-opening) may be expected to give rise to a copolymer with the functionality concentrated at one end of the chain, i.e. a higher number of epoxide or ring-opened epoxide functional groups are at one end of the chain that at the other. In a composition comprising a copolymer of the invention and a filler, the free chain ends of the copolymer may be expected to interact with the filler particles. In the case of compositions for use in tyres, this may be expected to lead to better rolling resistance of the tyre and better fuel efficiency of the vehicle.

sSBR copolymers in accordance with the second aspect of the invention in combination (e.g. admixture) with fillers, such as silica; carbon black and other carbon-based nanomaterials such as graphene and/or carbon nanotubes; clay; metal carbonates; and/or titanium dioxide, find use as curable compositions. It is to such compositions that the composition in accordance with the fifth aspect of the invention is directed. These compositions can be used in the preparation of vulcanised (cured) compositions to which the articles of the sixth aspect of the invention are directed.

The term “clay” used herein defines a natural rock or salt that comprises hydrous aluminium phyllosilicates with variable amounts of magnesium, alkali metals, alkaline earth metals and/or iron. Specifically, silicon dioxide, metal oxides and talc (i.e. H₂Mg₃(SiO₃)₄ or Mg₃Si₄O₁₀(OH)₂) lie within the ambit of the term “clay”.

The term “metal carbonates” defines any carbonate stabilised by metal cation(s). Preferably the metal cation(s) is an alkali metal or an alkaline earth metal. When the metal cation is an alkali metal, two singly-charged cations are required per carbonate ion, whereas when the metal cation is an alkaline earth metal, only one doubly-charged cation is required per carbonate ion.

Preferably, the filler material of the fifth aspect comprises silica or carbon black. Preferably, the curable composition of the fifth aspect of the invention comprises silica.

The composition of the fifth aspect of the invention typically comprises one or more vulcanisation initiators and optionally one or more vulcanisation accelerators.

Viewed from a sixth aspect, the present invention provides an article resultant from curing of the composition of the fifth aspect of the invention. For example, the articles of the sixth aspect of the invention may be any article comprising rubber. In particular, the article is an article likely to be subject to a degree of wear, such as an article chosen from tyres, gaskets, seals, inner tubes, shoe soles, hoses, belts, flooring etc. Thus, according to a particular embodiment, the invention provides a tyre comprising a cured composition of the fifth aspect of the invention. Preferably, the tread of the tyre is resultant from curing of the composition of the invention.

Each and every patent and non-patent reference referred to herein is hereby incorporated by reference in its entirety, as if the entire contents of each reference were set forth herein in their entirety.

The following non-limiting examples below serve to illustrate the invention further.

### Examples

The discussion that follows will focus on copolymers of myrcene, but it will be understood that the same applies to other copolymers comprising a backbone from which hydrocarbyl, trisubstituted ethylene-containing moieties are pendant.

I. Chemicals and their Preparation

Technical grade myrcene (75%, Sigma Aldrich UK), ReagentPlus styrene (99%, Sigma Aldrich UK), Isoprene (99%, Sigma Aldrich UK), ocimene (>90%, mixture of trans-β and cis-β isomers, Sigma Aldrich) and anhydrous benzene (99.8%, Sigma Aldrich UK) were dried and degassed, using extra pure calcium hydride (93%, 0-2 mm grain size, Acros Organics) and the freeze-pump-thaw method. 1,3-butadiene (≥99.6%, Sigma Aldrich UK) was purified by passing through molecular sieves before being sacrificially initiated with n-butyllithium solution (n-BuLi) (2.5 M in hexanes, Sigma Aldrich UK) prior to distillation. Sec-butyllithium (sec-BuLi) (1.4 M in cyclohexanes, Sigma Aldrich UK), N,N,N′,N′tetramethylethylenediamine (TMEDA) (99.5%, Sigma Aldrich UK), DTHFP (a statistical ratio of meso, D and L isomers), analytic reagent grade DCM (99.99%, Fisher Scientific UK), analytical reagent grade methanol (99.99%, Fisher Scientific UK), butylated hydroxytoluene (BHT) (99%, Sigma Aldrich UK), laboratory reagent grade chloroform (≥99%, Fisher Scientific UK), ReagentPlus benzylamine (99%, Sigma Aldrich UK), HPLC gradient grade acetonitrile (Fisher Scientific UK), sodium azide (NaN₃) (≥99.0%, purum p.a., Sigma Aldrich UK), lithium aluminium hydride solution (1.0 M in THF, Sigma Aldrich UK), laboratory reagent grade magnesium sulphate (MgSO₄) (dried, Fisher Scientific UK), sodium hydrogen carbonate (NaHCO₃) (2.5% Na₂CO₃, −40+140 mesh, Sigma Aldrich UK) and 3-chloroperbenzoic acid (m-CPBA) (s 77%, Sigma Aldrich UK) were all used without any further purification. Bromine end capped polybutadiene (M, of 50,400 g mol-1) was prepared in house.

### II. Characterisation

Triple detection Size Exclusion Chromatography (SEC) for molar mass analysis was carried out using a Viscotek GPC max VE2001 solvent/sample module and a Viscotek TDA 302 (Triple Detector Array) at 35° C. with a 1 mL min⁻¹ flow rate. A dn/dc value of 0.131 mL g⁻¹ was used for polymyrcene in THF, a dn/dc value of 0.185 mL g⁻¹ was used for polystyrene in THF, adn/dc value of 0.144 mL g⁻¹ was used for polyisoprene in THF and a dn/dc value of 0.124 mL g⁻¹ was used for polybutadiene in THF.

Nuclear Magnetic Resonance (NMR) spectroscopy was carried out using a Bruker Advance III 400 MHz spectrometer with an operating frequency of 400.130 MHz for ¹H nuclei and 100.613 MHz for ¹³C nuclei, using deuterated chloroform (CDCl₃) as the solvent.

High Resolution NMR spectroscopy was carried out using a Varian VNMRS 700 MHz spectrometer with an operating frequency of 700.130 MHz for ¹H nuclei and 176.048 MHz for ¹³C nuclei, using CDCl₃ as the solvent.

Differential Scanning calorimetry (DSC) was performed with a Mettler Toledo DSC-1 in a temperature range from −100° C. to 150° C. with a heating rate of 10 K min⁻¹

### III. Living Anionic Polymerisation

All polymers (homopolymers, copolymers and terpolymers) were synthesised by “living” anionic polymerisation in benzene (unless otherwise stated) at room temperature, using standard high vacuum techniques. All chemicals were prepared as described above, and all distillations were preformed trap to trap, under ultra-high vacuum conditions.

In a typical reaction polymyrcene (PM1) was synthesised thus; dry degassed benzene (50 mL) was distilled via the Schlenk line into the reaction vessel. Dry, degassed myrcene (5.47 g, 40.2 mmol) was distilled into a clean dry flask and weighed, before being distilled via the Schlenk line into the reaction vessel. A freeze-pump-thaw cycle was then carried out on the monomer solution, before warming to room temperature. For a target molar mass of 10,000 g mol⁻¹ sec-BuLi (391 μL, 547 μmol) was then injected into the solution to initiate polymerisation. The solution was then left to stir for 19 hours at room temperature before the reaction was terminated through the injection of nitrogen-sparged methanol (1.00 mL, 24.7 mmol). The polymer was then precipitated into methanol (500 mL), which contained a small amount of (BHT) (0.01 g), before being allowed to settle for 16 hours. The methanol was then decanted off and the polymer was washed with methanol. Polymer (PM1) was collected, dried under vacuum to give 4.15 g (76%) of viscous rubbery polymer.

When block copolymers were synthesised, the first monomer was polymerised to full conversion using the general method described above, before a second monomer was added. The sample was then terminated after complete conversion of the second monomer.

When statistical co/terpolymers were synthesised, 2 or 3 monomers were added at the start and then polymerised simultaneously using the method described. In some cases, where the reactivity ratios were to be changed to synthesise a random co/terpolymer, TMEDA (2 molar equivalents compared to the moles of sec-BuLi used) was injected into the monomer solution just prior to initiation by sec-BuLi.

All polymer samples were synthesised using the general method described above, where the amounts of monomers and initiator, time of reaction, and target Mₙ for each sample can be found in the “Synthetic procedures and characterisation” section.

### IV. Microstructure of Butadiene Polymers

The microstructure of 1,3-butadiene, when incorporated into a polymer via living anionic polymerisation, depends on which carbon of the propagating unit attacks the next monomer. The three different possible microstructures are known as (1,2), (1,4)-cis and (1,4)-trans. These are depicted in Scheme (2), below.

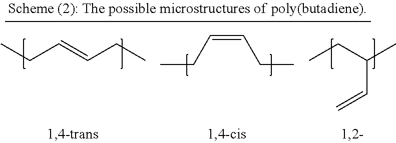

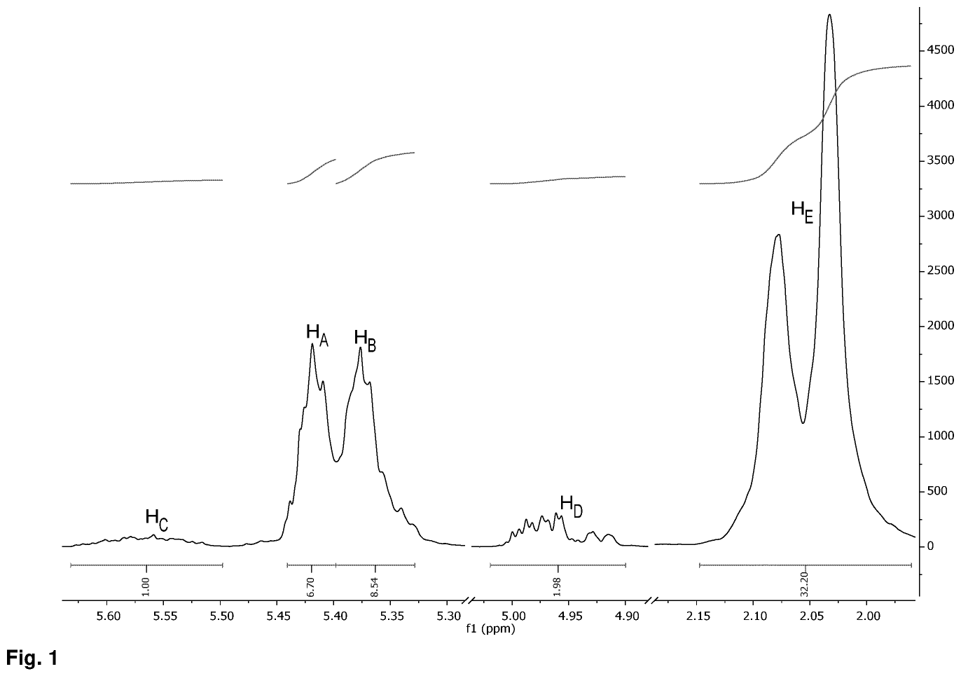

The most common method used to differentiate between these microstructures is ¹H Nuclear Magnetic Resonance (NMR) spectroscopy. The three different microstructures that result on incorporation of butadiene into a polymer provide three distinct sets of ¹H NMR signals, as shown in FIG. 1. Many experimental conditions can affect the microstructures of the synthesised polymer including: solvent polarity, temperature, counter cation and any randomising agents or salts. Typically in a non-polar solvent such as benzene or cyclohexane, the resulting microstructure is 90-95% 1,4-poly(butadiene).

### V. Microstructure of Isoprene Polymers

Four different possible microstructures of isoprene can arise, when incorporated into a polymer via living anionic polymerisation, namely, (4,1)-cis and trans, (4,3)- and (1,2)-. These are shown in Scheme (3), with the (4,1)-microstructure shown only as the trans isomer. Although all indicated microstructures are possible, the (1,2)-microstructure is usually only seen when using polar solvents, and then is a minor contributor.

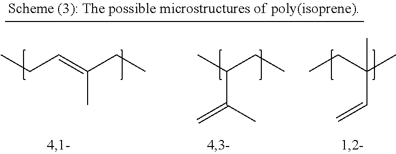

Many experimental conditions can affect the microstructures of the synthesised polymer including: solvent polarity, temperature, counter cation and any randomising agents or salts. Typically in a non-polar solvent such as benzene or cyclohexane, the resulting microstructure is 90-95% 4,1-poly(isoprene).

### VI. Microstructure of Myrcene Polymers

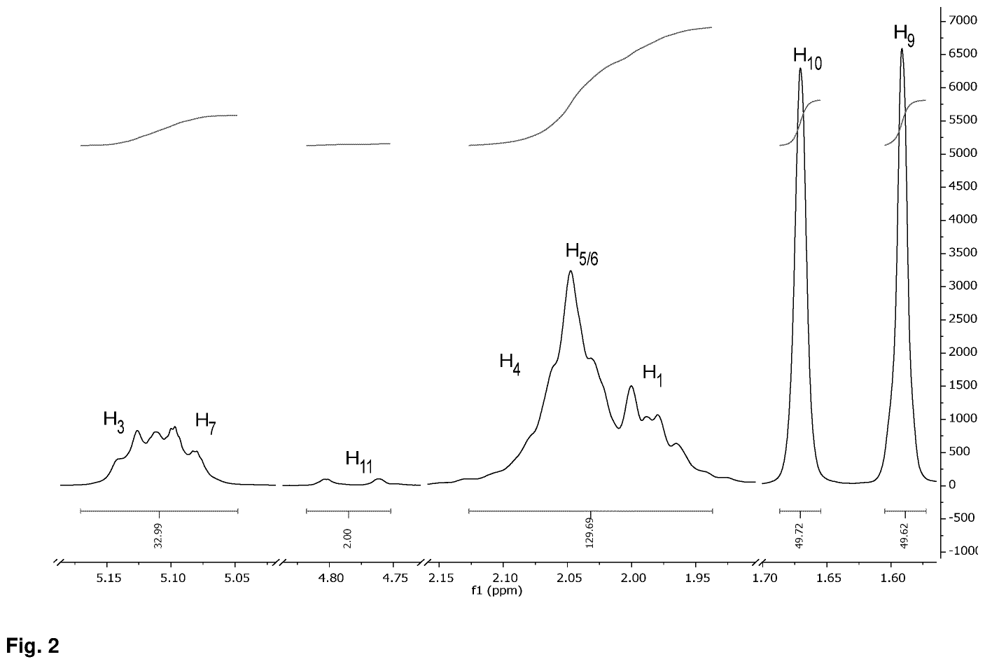

Four different possible microstructures of myrcene can also arise, when incorporated into a polymer via living anionic polymerisation, namely, (4,1)-cis and trans, (4,3)- and (1,2)-. These are shown in Scheme (4), with the (4,1)-microstructure shown only as the trans isomer. Although all indicated microstructures are possible, the (1,2)-microstructure is usually only seen when using polar solvents, and then is a minor contributor. The copolymers described herein were prepared in benzene and no (1,2)-microstructure was observed. The most common method used to differentiate between these microstructures is ¹H Nuclear Magnetic Resonance (NMR) spectroscopy. However, the corresponding 1H NMR spectra of the different microstructures contain only two distinct sets of ¹H NMR signals due to the nearly perfect overlap of the (4,1)-cis and (4,1)-trans signals (see, for example, FIG. 2) The ¹H NMR spectrum (FIG. 2) of PM1 indicates a microstructure composition of 94% (4,1) and 6% (4,3).

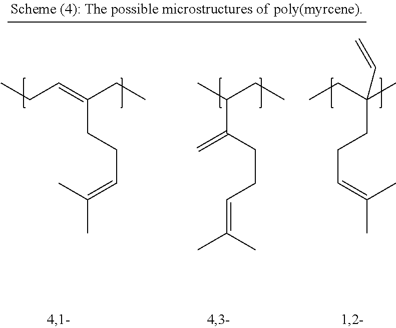

### VII. Microstructure of Ocimene Polymers

Ocimene can exist as both α- and β-isomers. Only the β-isomer can give rise to a pendant hydrocarbyl, trisubstituted ethylene-containing moiety when polymerised, thus only R-ocimene is considered here. R-ocimene can exist as both cis- and trans-isomers (see Scheme (5)) and both are capable of undergoing anionic polymerisation via the 1,3-diene moiety.

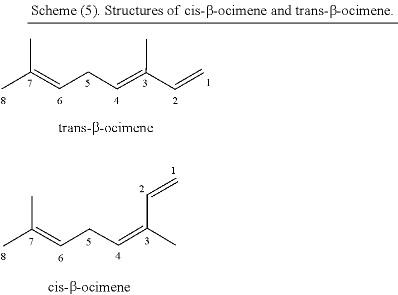

Each isomer of β-ocimene is able to adopt multiple different possible microstructures when incorporated into a polymer via living anionic polymerisation, namely, (1,4)-cis and trans, (1,2)-, (4,1)-cis and trans and (4,3)-. These are shown in Scheme (6) for cis-β-ocimene only.

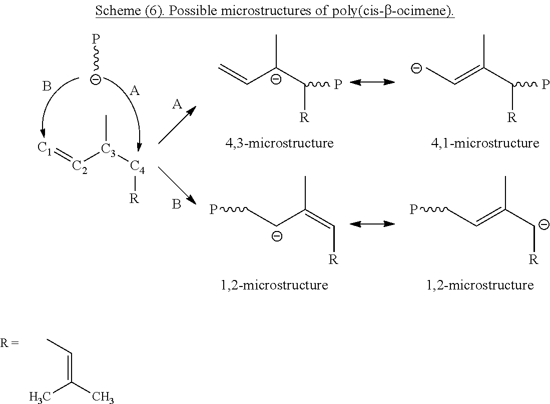

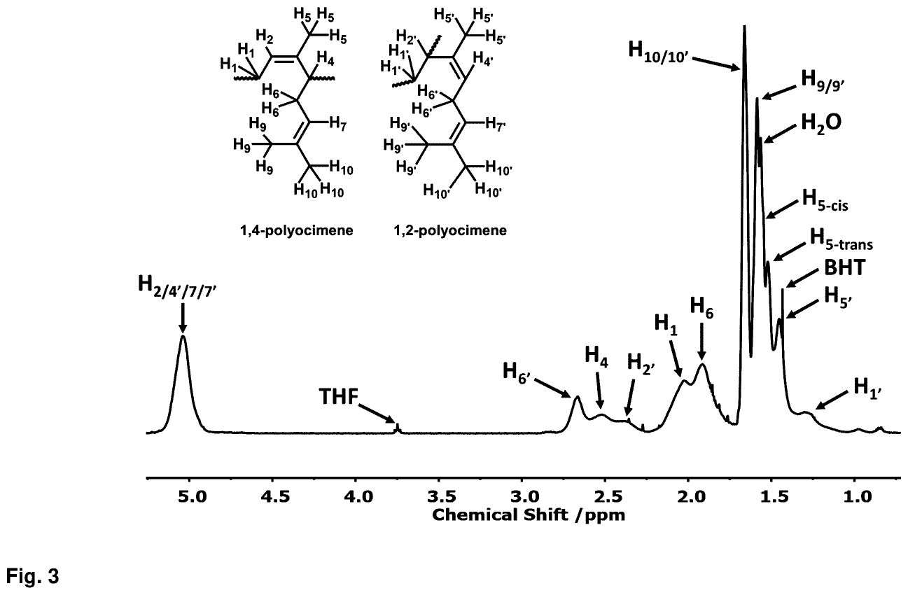

Although all indicated microstructures are possible, attack by the propagating carbanion on carbon 4 is unlikely due to steric and electronic effects. The microstructure can vary significantly with experimental conditions, especially solvent polarity, and the fraction of (1,2)-microstructure generally increases with increasing solvent polarity. The polymers described in this section were prepared in non-polar solvents such as toluene or benzene. However, the specific steric and electronic stability of the propagating carbanion of ocimene following attack on C1, due to the presence of alkyl substituents on C3 and C4, results in a higher fraction of (1,2)-microstructure in polyocimene prepared in non-polar solvents, than observed for other dienes such as butadiene, isoprene and myrcene. Typically in a non-polar solvent such as benzene or toluene, the resulting microstructure is approximately 65-70% 1,4-poly(ocimene). The most common method used to differentiate between these microstructures is NMR spectroscopy. The ¹H NMR spectrum (FIG. 3) of POc1 indicates a microstructure of 71% (1,4) and 29% (1,2) assuming that only 1,4 and 1,2 microstructures exist.

### VIII. Epoxidation of Tri-Substituted Ethylene-Containing Copolymers

Several different epoxidation methods using m-CPBA are known, with varying extremes of conditions required. The different conditions were compared with ambient conditions to investigate what effect, if any, the conditions had on the selectivity and extent of epoxidation.

All of the methods used approximately the same amount of a statistical copolymer of butadiene and myrcene (PMB1) (0.25 g) and approximately the same amounts of m-CPBA (0.11 g). The same work up was used for each reaction afterwards as described in the general method, below.

### VIII.I General Method for Epoxidation

The copolymer (0.25 g) was dissolved in DCM (30 mL), placed under a nitrogen atmosphere and cooled to approximately 0° C. m-CPBA (0.11 g) was dissolved in DCM, under N₂ at 0° C. or at −10° C., before being injected into the polymer-containing solution.

This solution was stirred under N₂ at 0° C. or at −10° C. for 2 hours. The reaction mixture was then washed with 0.1 M NaHCO₃ solution (100 mL) before the organic layer was separated, dried with MgSO₄ (0.21 g) and precipitated into methanol (300 mL). The product was then allowed to settle for 16 hours before the methanol was decanted off and the remaining product was washed with acetone, water and methanol. The product was then collected, dried under high vacuum and weighed (see R. Pandit et al(supra)).

Where high percentages of epoxidation were required chloroform (5 mL) was also added to prevent the epoxidised copolymer from precipitating out of solution.

Generally, the amount of m-CPBA used was approximately equal to the amount required to epoxidise 100% of the pendant trisubstituted ethylene-containing moieties derived from myrcene and was calculated using Equation (1.2) and Equation (1.3) below.

$$( 1.2 )$$

$$Moles of double bonds \text{/} mol = \frac{No . of double bonds per repeat unit \times Mass of polymer \text{/} g}{Molar mass of repeat unit \text{/} g {mol}^{- 1}}$$

$$( 1.3 )$$

$$Mass of m \text{-} CPBA \text{/} g = Target epoxidation \times Moles of double bonds / mol \times Molar Mass of m \text{-} CPBA \text{/} g {mol}^{- 1}$$

All epoxidised polymers were synthesised using the general method described above, where the amounts of copolymer and m-CPBA.

### IX. Chemoselectivity of the Epoxidation in Myrcene-Butadiene Copolymers

The extent and selectivity of epoxidation towards myrcene and butadiene double bonds in PMB1, and the total extent of epoxidation was obtained using NMR data (see below) and the results reported in Table 2 and discussed herein. There was no significant impact of conditions on either the selectivity or total extent of epoxidation (see Tables 1 and 2). The best selectivity proved to be when the epoxidation was carried out under N₂ atmosphere at approximately 0° C. (−0.5 to +0.5° C.), thus all subsequent epoxidation reactions of myrcene-containing polymers were carried out under these conditions. However, the epoxidation reaction also works with high selectivity at room temperature (RT) under ambient conditions. Such inexpensive conditions may be beneficial to industrial production.

TABLE 1
The reaction conditions used for the epoxidation
of PMB1, a statistical copolymer of myrcene and butadiene,
with a molar feed of 26% myrcene and 74% butadiene, and a
target Mn of 60,000 g mol⁻¹.

| Sample | Temp./° C. | Conditions |
|---|---|---|
| EPMB1-1 | 0 | Under N₂ |
| EPMB1-4 | 0 | NaHCO₃ (aq) |
| EPMB1-5 | RT | NaHCO₃ (aq) |
| EPMB1-6 | 0 | Ambient |
| EPMB1-7 | RT | Ambient |
| EPMB1-8 | −78 | Under N₂ |
| EPMB1-12 | RT | Under N₂ |

TABLE 2
The extent and selectivity of epoxidation of PMB1, a statistical
copolymer of myrcene and butadiene, with a molar feed of 26%
myrcene and 74% butadiene, and a target Mn of 60,000 g mol⁻¹.

| | Extent of epoxidation of | | Selectivity of epoxidation |
|---|---|---|---|
| | alkene bonds/% | | of myrcene alkene bonds |
| | All alkene | All myrcene alkene | over butadiene alkene |
| Sample | bonds | bonds | bonds |
| EPMB1-1 | 11 | 88 | 21 |
| EPMB1-4 | 9 | 86 | 17 |
| EPMB1-5 | 9 | 85 | 16 |
| EPMB1-6 | 10 | 88 | 21 |
| EPMB1-7 | 11 | 84 | 15 |
| EPMB1-8 | 11 | 84 | 15 |
| EPMB1-12 | 8 | 86 | 17 |

Approximately 10% (specifically 8-11%) of all alkene bonds in PMB1 were converted to epoxide rings and the high selectivity of this reaction towards a trisubstituted alkene resulted in between 84 and 88% epoxidation of all myrcene alkene bonds. Moreover, given the high selectivity of the epoxidation reaction for the pendant 7,8-myrcene trisubstituted alkene double bond in the final product, as indicated in Scheme (7), of all the epoxide groups introduced—between 69 and 75% of those epoxide groups were derived from a pendant 7,8-myrcene alkene double bond. Such is the selectivity of the epoxidation reaction that a myrcene alkene double bond is approximately 20 times more likely to be epoxidised than a butadiene double bond.

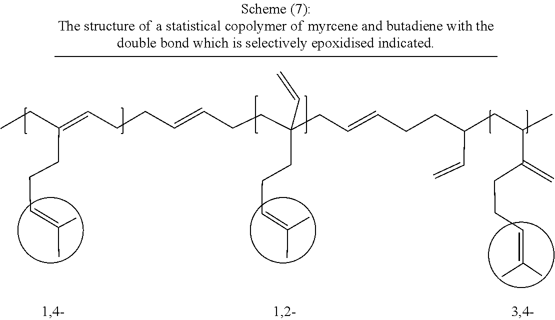

### IX. Method to Calculate Total Amount of Epoxidation

The method used to calculate the total amount of epoxidation (i.e. total number of alkene bonds epoxidised) is exemplified for a poly(myrcene) sample (PM1).

For simplicity, it is assumed that the microstructure of poly(myrcene) (PM1) is 100% 4,1-. In reality the microstructure is actually 94% 4,1- and 6% 4,3-.

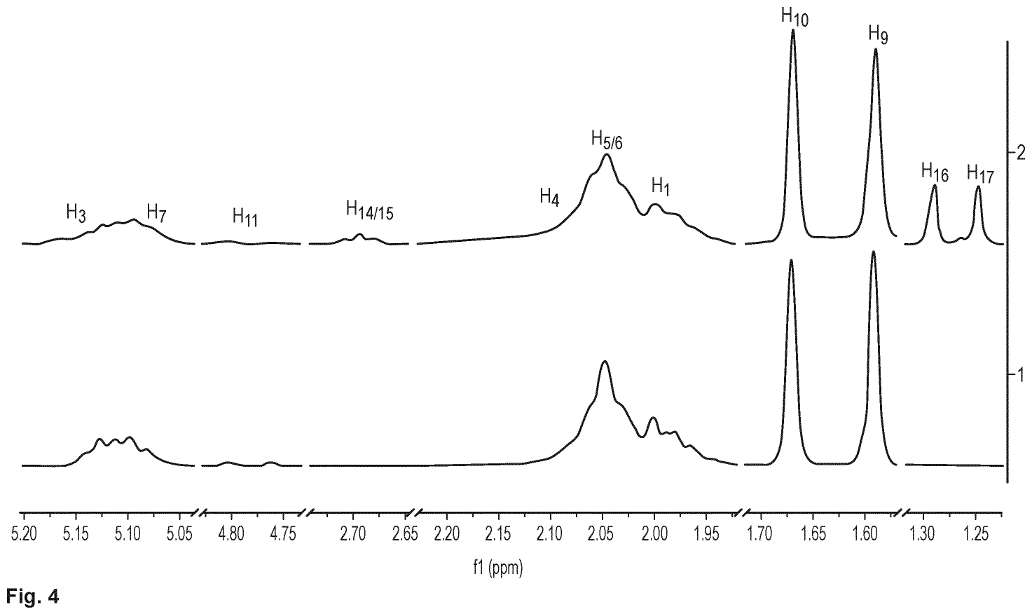

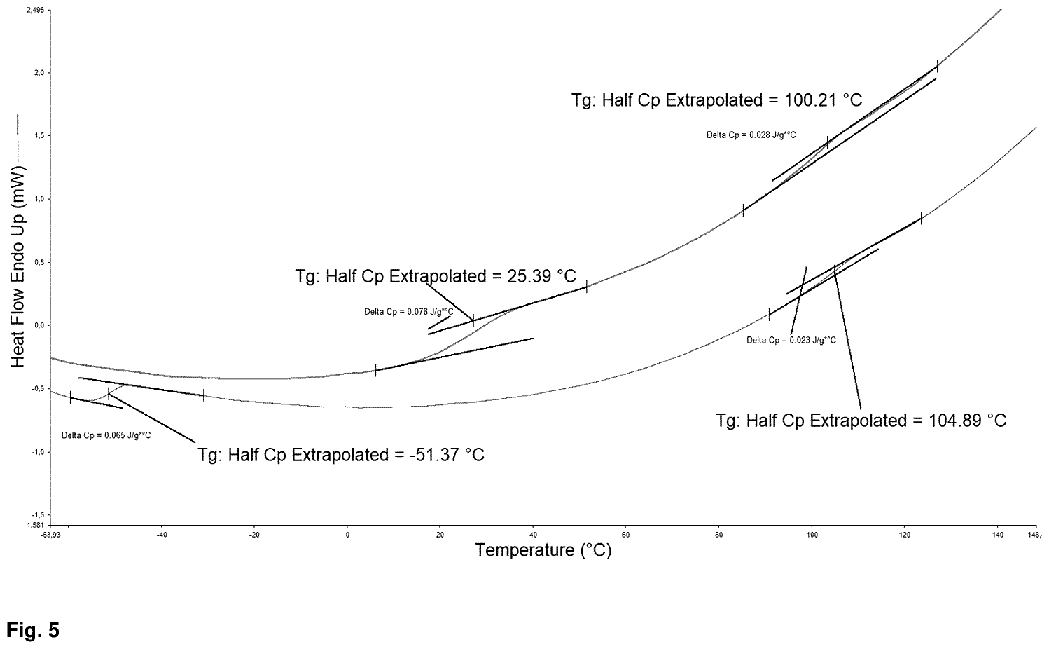

Overlaid NMR spectra corresponding to epoxidised and unepoxidised poly(myrcene) are shown in FIG. 4. These spectra contain a single broad peak at 2.69 ppm, which corresponds to H₁₄ and H₁₅ of Scheme (8), i.e. the hydrogen atoms arising from epoxidation of the backbone (3,2) double bond to give the 3,2 epoxide (cis or trans) (H₁₄) and epoxidation of the pendant 7,8 double bond, to give the 7,8 epoxide (H₁₅) (see Scheme (8), below). Two new peaks at 1.25 ppm and 1.29 ppm are present in the spectrum displaying signals for epoxidised poly(myrcene), and these peaks correspond to hydrogen atoms H₁₆ and H₁₇, which correspond to the hydrogen atoms of the two methyl groups bonded to the 7,8 epoxide. The broad peak between 5.05 and 5.20 ppm corresponds to overlapping signals which can be assigned to H₃ and H₇, i.e. the single hydrogen atoms bonded directly to the 3,2 and 7,8 trisubstituted alkenes prior to epoxidation. H₃ and H₇ are transformed into H₁₄ and H₁₅ respectively, upon epoxidation.

The total extent of epoxidation of alkene double bonds in poly(myrcene) (PM1) was calculated using the integral values of the appropriate peaks in the spectrum of the epoxidised poly(myrcene) according to equation (1.4), and was found to be 25%.

$$Epoxidation \% = \frac{Integral of ( {H}_{14} + {H}_{15} ) \times 100 \%}{Integral of ( {H}_{14} + {H}_{15} ) + Integral of ( {H}_{3} + {H}_{7} )} \qquad ( 1.4 )$$

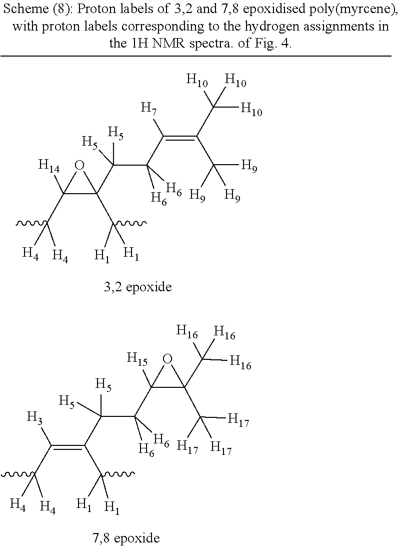

The selectivity of the epoxidation reactions, i.e. which of the trisubstituted double bonds—backbone 3,2 or pendant 7,8—were epoxidised preferentially, was also determined. Using the integral values of the appropriate peaks and equation (1.5) it was shown that approximately 69% of the epoxidation occurred at the 7,8 double bond. Based on the degree of substitution alone, one would expect that both the 3,2 and the 7,8 double bonds would have the same degree of epoxidation. Without wishing to be bound by theory, the high degree of preference for epoxidation of the 7,8 pendant double bond seems to result from steric effects.

$$7 , 8 epoxidation selectivity \% = \frac{Integral of ( {H}_{16} + {H}_{17} ) \times 100 \%}{6 \times Integral of ( {H}_{14} + {H}_{15} )} \qquad ( 1.5 )$$

### X. Chemoselectivity of the Epoxidation in Myrcene-Styrene Copolymers

Although the addition of styrene provides no further double bonds to the backbone of the copolymer, epoxidation of PMS1, a tapered block copolymer with a molar feed ratio of 49% myrcene and 51% styrene and a target Mₙ of 70,000 g mol⁻¹, was carried out to investigate the effect of the phenyl group of styrene on the internal selectivity of myrcene. 0.25 g of PMS1 was reacted with 0.15 g of m-CPBA in DCM under N₂ at 0° C., in accordance with the general method outlined above, the amount of m-CPBA used was just sufficient to epoxidise all the 7,8 double bonds. EPMS1, a white solid, was collected, giving a yield of 48%. The total extent of double bond epoxidation was calculated from the NMR signals of EPMS1 to be 22%. Moreover, given the high selectivity of the epoxidation reaction for the pendant 7,8-myrcene alkene double bond in the final product, of all the epoxide groups introduced—approximately 66% of those epoxide groups were derived from a pendant 7,8-myrcene alkene double bond. This is in line with the results obtained for epoxidation of myrcene homopolymers, suggesting that the addition of styrene has little to no effect on the selectivity of epoxidation by m-CPBA in poly(myrcene-co-styrene).

### XI. Chemoselectivity of the Epoxidation in Myrcene-Butadiene-Styrene Terpolymers

A study was undertaken into the chemoselectivity of epoxidation using m-CPBA to investigate whether the 7,8 double bond of myrcene would be selectively epoxidised in a terpolymer comprising styrene, butadiene, and myrcene. 0.25 g of PMBS1, a statistical terpolymer with a molar feed ratio of 28% myrcene, 34% styrene and 38% butadiene and a target Mₙ of 80,000 g mol⁻¹, was reacted with 0.10 g of m-CPBA in DCM under N₂ at 0° C. in accordance with the general method for epoxidation. Enough m-CPBA was added to epoxidise all the 7,8 double bonds. 0.20 g of EPMBS1, a white powder, was recovered, giving a yield of 74% and a total extent of epoxidation of 11% of all alkene double bonds.

NMR spectral data indicated that epoxidation occurred at both the butadiene 2,3 double bond and the myrcene 3,2 and 7,8 double bonds. It was calculated, from the integral values of the relevant signals, that 72% of the epoxidation occurred at the myrcene 7,8 double bond, 20% occurred at the myrcene 3,2 double bond and only 8% occurred at the butadiene 2,3 double bond. These results are in broad agreement with the results observed for the epoxidation of PMB1, which again suggests that the addition of styrene has no observable effect on the high chemoselectivity of m-CPBA for a tri-substituted, pendent alkene double bond.

This high selectivity suggests that the 7,8 double bond could be a viable site for functionalisation of rubbers for tyre applications, even if only small quantities of myrcene were incorporated into the rubber.

A further terpolymer was tested, with a molar composition of 4% myrcene, 74% butadiene and 22% styrene. This terpolymer had been synthesised by living anionic polymerisation in the presence of a randomiser (TMEDA) (PMBS(TMEDA)2), and was epoxidised to see if myrcene could be selectivity epoxidised, even when present at a very low mole fraction.

0.25 g of PMBS(TMEDA)2 was reacted with 0.02 g of m-CPBA in DCM under N₂ at 0° C. in accordance with the conditions used above, aiming for total epoxidation of all the 7,8 double bonds. 0.23 g of a cloudy, viscous, gel-like product was recovered (EPMBS+T1) in 92% yield.

The NMR signals indicated that the 7,8 double bond of myrcene was epoxidised, despite the small amount of myrcene present. The m-CPBA again showed chemoselectivity for myrcene over butadiene. This indicated that even small amounts of myrcene could be added to commercially manufactured sSBR, and then be selectively epoxidised. Ring-opening of such epoxides may be expected to increase the polarity of the copolymer, thereby improving the dispersion of filler particles therein.

### XII. Chemoselectivity of the Epoxidation in Myrcene-Isoprene-4-Methylstyrene

Terpolymers A series of terpolymers of myrcene, isoprene and 4-methylstyrene were prepared by living anionic polymerisation to investigate the chemoselectivity of the epoxidation of myrcene in the presence of isoprene. It has been shown above that there is a high degree of selectivity of epoxidation (using m-CPBA) towards the trisubstituted 7,8 alkene double bond of polymyrcene over the similarly trisubstituted 3,2 (backbone) double bond and all double bonds of polybutadiene. The dominant 4,1 microstructure of polyisoprene also contains a trisubstituted 3,2 (backbone) double bond but which is much more sterically available than the analogous 3,2 polymyrcene double bond. All terpolymers were prepared with a target molar mass of 60 kg/mol and a 4-methylstyrene content of c. 50 mol %, while the myrcene and isoprene content was systematically varied from 0 to 50 mol %.

XII.I General Synthetic Procedure for the Production of myrcene-butadiene-4-methylstyrene Statistical Terpolymers

In a typical terpolymerisation, for a monomer molar feed ratio of myrcene (20%), butadiene (30%) and 4-methylstyrene (50%) a mixture of 0.804 g (11.8 mmol) isoprene, 1.072 g (7.87 mmol) myrcene and 2.32 g (19.7 mmol) 4-methylstyrene was dried over CaH₂ under an argon atmosphere and degassed by three freeze-thaw cycles. Cyclohexane was dried over polystyryllithium and degassed by three freeze-thaw cycles. The monomer mixture and cyclohexane were transferred into a round bottom flask equipped with a rubber septum and a magnetic stirrer bead. 0.05 ml of the initiator (1.4 M sec-butyllithium) were added via syringe and the copolymer solution was stirred overnight. The polymerisation was terminated by adding 0.5 ml of degassed isopropyl alcohol via syringe and precipitated in a 10-fold access of isopropyl alcohol, containing a small amount of BHT as stabilizer.

### XII.II Results

A series of terpolymers was made by the same method, with varying feed ratios (see Table 3). Due to the strong overlap of the signals of polyisoprene and polymyrcene, it was not possible to calculate the composition of the resulting copolymers via NMR. However, real-time NMR analysis of the terpolymerisation revealed a tapered triblock-like structure with myrcene consumed in preference to isoprene and 4-methylstyrene being the final monomer to be incorporated (see E. Grune et al, Polym. Chem., 2019, 10, 1213-1220).

TABLE 3
Molar mass, feed ratio and glass transition temperature data for
statistical copolymers of myrcene, isoprene and 4-methylstyrene.

| | Monomer Feed Ratio (mol %) | | | | | | |
|---|---|---|---|---|---|---|---|
| | | Iso- | 4-methyl- | Mn | | T_{g}1 | T_{g}2 |
| Sample | Myrcene | prene | styrene | (kg/mol) | Ð | (° C.) | (° C.) |
| PMI4MS1 | 10 | 40 | 50 | 67.0 | 1.08 | −53 | 106 |
| PMI4MS2 | 20 | 30 | 50 | 65.9 | 1.08 | −57 | 107 |
| PMI4MS3 | 30 | 20 | 50 | 71.5 | 1.09 | −59 | 101 |
| PMI4MS4 | 40 | 10 | 50 | 64.0 | 1.12 | −61 | 102 |

DSC measurements (see Table 3) were used to investigate the impact of copolymerisation kinetics on the glass transition temperature(s) of the terpolymers. In the case of each terpolymer, two glass transitions were observed. One at between 101 and 107° C., corresponding to a 4-methylstyrene rich block and a second T_{g} at between 53 and 61° C. This second T_{g} is rather broad and varies with diene composition. The presence of a single glass transition for the diene-rich block is perhaps not surprising given that the glass transition temperature of polyisoprene and polymyrcene synthesised under similar conditions are rather similar (−60° C. and −65° C. respectively) and although real-time NMR analysis would suggest a tapering from myrcene to isoprene, even a perfect block copolymer of the two monomers would likely yield overlapping glass transitions.

### XII.III Epoxidation of Myrcene, Isoprene, 4-Methylstyrene Terpolymers

A second, similar series of copolymers and terpolymers were prepared by living anionic polymerisation to investigate the chemoselectivity of the epoxidation of myrcene in the presence of isoprene—see Table 4.

TABLE 4
Results of DSC analysis copolymer/terpolymers and
epoxidised copolymer/terpolymers with a constant feed
fraction of 4-methylstyrene of 50 mol %.

| | Monomer Feed | | | | |
|---|---|---|---|---|---|
| | Ratio (mol %) | | T_{g}¹ | T_{g}² | T_{g}³ |
| Sample | Myrcene | Isoprene | (° C.) | (° C.) | (° C.) |
| PI4MS1 | 0 | 50 | −51.4 | — | 104.9 |
| EPI4MS1 | 0 | 50 | — | 25.4 | 100.2 |
| PMI4MS5 | 10 | 40 | −53.2 | — | 106.0 |
| EPMI4MS5 | 10 | 40 | −54.9 | −30.4 | 101.2 |
| PMI4MS6 | 20 | 30 | −56.6 | — | 107.1 |
| EPMI4MS6 | 20 | 30 | −64.1 | −28.6 | 98.8 |
| PMI4MS7 | 30 | 20 | — | — | — |
| EPMI4MS7 | 30 | 20 | −61.2 | −38.6 | 104 |
| PMI4MS8 | 40 | 10 | — | — | — |
| EPMI4MS8 | 40 | 10 | — | −19.5 | 98.5 |
| PM4MS1 | 50 | 0 | — | — | — |
| EPM4MS1 | 50 | 0 | — | −23.4 | 104 |

### XII.IV General Epoxidation Procedure, Using PMI4MS6 Terpolymer as an Example

500 mg of PMI4MS6 (12.7 mmol myrcene) and 219 mg m-chloroperoxybenzoic (mCPBA) acid (75% purity, 12.7 mmol) were dissolved in 4 ml DCM in a round bottom flask equipped with a rubber septum, magnetic stirrer bar and an argon balloon. 4 ml of a 0.1 M sodium hydrogenate solution were added via syringe and stirred for 1.5 h at room temperature. The solution was precipitated in an 8-fold excess of methanol without any extraction steps.

All of the terpolymers, along with selected diblock copolymers of isoprene/4-methylstyrene (50/50—PI4MS1) and myrcene/4-methylstyrene (50/50—PM4MS1), both before and after epoxidation, were investigated by DSC (Table 4).

Epoxidation using the standard m-CPBA method on PI4MS1, a diblock copolymer of isoprene and 4-methylstyrene, yielded EPI4MS1 in which epoxidation is only able to occur on the polyisoprene block and occurs with an efficiency of approximately 52%. Epoxidation of the vinyl groups was not observed, indicating a strong selectivity for trisubstituted double bonds. Moreover, epoxidation of the isoprene block resulted in a dramatic increase in glass transition from −51.4° C. to 25.4° C.—see FIG. 5. Epoxidation of PM4MS1, a diblock copolymer of myrcene and 4-methylstyrene yielded EPM4MS1 in which epoxidation is only able to occur on the polymyrcene block, which also lead to an increase in glass transition from −51.4° C. to −23.4° C.

Epoxidation of the terpolymers resulted in some telling insights. For a myrcene content of 10 to 30 mol % the appearance of three separate glass transitions was observed following epoxidisation. The lowest T_{g} appeared at about −55 to −65° C., a second T_{g} was observed in the range of −39° C. to −28° C. and a third T_{g} was observed at about 100° C. This presence of three glass transitions suggests a triblock-like structure, and is consistent with the real-time NMR analysis of this terpolymer (see E. Grune et al, Polym. Chem., 2019, 10, 1213-1220). However, whilst only two glass transitions were observed for the terpolymer prior to epoxidation, for the reasons explained above, the fact that three glass transitions can be observed in the epoxidised terpolymers not only suggests a triblock like structure but that the epoxidation reaction is highly selective towards the epoxidation of the myrcene units. Thus the lowest glass transition at −55 to −65° C. can be attributed to a polyisoprene rich block, which has not been significantly epoxidised, the T_{g} at −39° C. to −28° C. can be attributed to a myrcene rich block which has been epoxidised and the highest T_{g} at 100° C. can be attributed to a 4-methylstyrene rich block. We do not claim that the monomer sequence is a perfect triblock copolymer, nor do we suggest that the epoxidation is 100% selective for myrcene. However, we strongly believe that the described DSC data, strongly evidences the described structure of the epoxidised terpolymer.

### XIII. Epoxidation of Poly(Ocimene)

Epoxidation of poly(ocimene) homopolymer (POc1) was carried out using a similar method to the general method described earlier. POc1 (0.27 g, 10.3 μmol) was dissolved in DCM (10 mL) before being cooled to −10° C. Afterwards, m-CPBA (0.09 g, 77% purity, 402 μmol)—sufficient to epoxidise 20% of the ocimene double bonds—was dissolved in DCM (15 mL) and slowly added to the polymer solution. This solution was stirred at −10° C. for 3 hours under argon. The reaction mixture was then washed with saturated NaHCO₃ solution before the organic layer was separated, dried with MgSO₄ and precipitated into a large excess of methanol. EPOc1 (0.21 g, 76%) was then collected and dried under reduced pressure.

### XIII.I Method to Estimate Total Amount of Epoxidation of Poly(Ocimene)

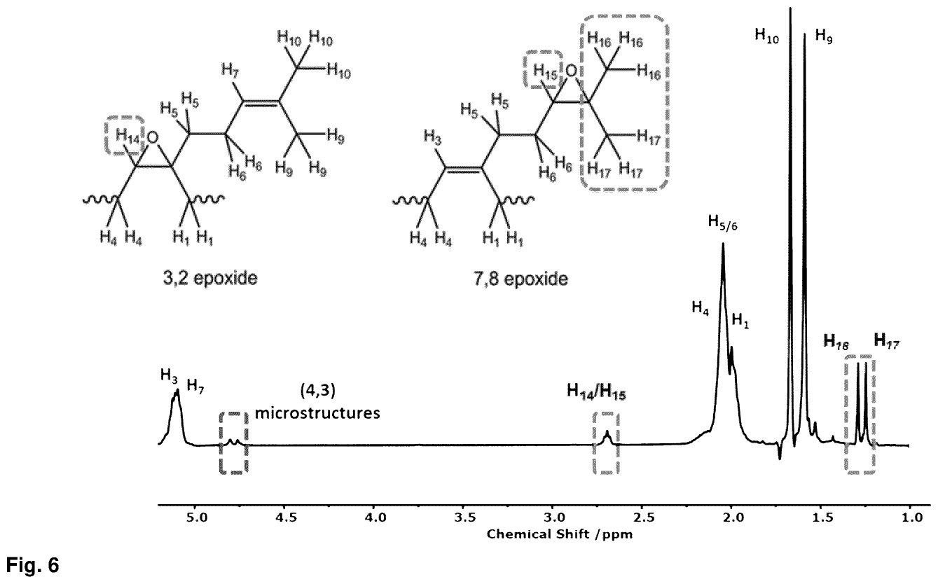

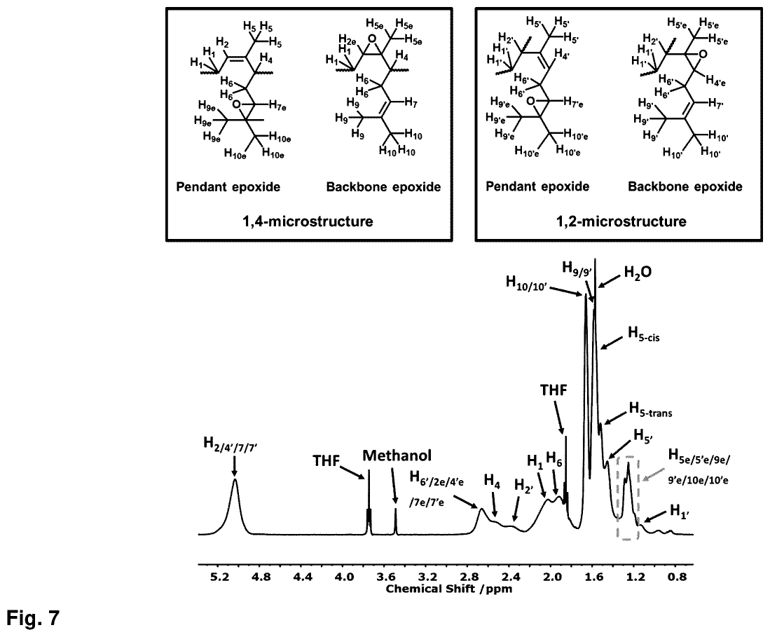

The NMR spectra of FIGS. 2 and 6 clearly evidence the epoxidation of poly(myrcene). In FIG. 6, the methyl protons (H₉ and H₁₀) of pendant trisubstituted alkene at approximately 1.6 and 1.7 ppm, shift upfield to approximately 1.25 and 1.3 ppm (H₁₆ and H₁₇) following epoxidation. Although the peaks for the analogous methyl protons in the NMR spectrum for poly(ocimene) (FIG. 3) are not so well-resolved (probably due to the more complex distribution of microstructures and a higher fraction of 1,2 repeat units), it is possible to assign the methyl protons bonded to the alkene (H₉/H₉, and H₁₀/H_{10′}) for both 1,4 and 1,2 microstructures (see insets in FIG. 3 for proton labels). When considering the ¹H NMR spectrum of the epoxidised polymer (FIG. 7), compelling qualitative evidence of successful epoxidation is immediately clear, in that new peaks emerge upfield at approximately 1.2-1.35 ppm (within the box in FIG. 7), which correspond to the aforementioned methyl protons after epoxidation.

All peak integrals, for both POc1 (FIG. 3) and EPOc1 (FIG. 7) may be normalised relative to the peak at 0.8-0.9 ppm, which arises due to methyl protons introduced by the initiator (sec-BuLi) and which is not effected by the epoxidation reaction. Thus, the peak at 0.8-0.9 is given the same integral value in both spectra. It should be noted that the peak at 0.8-0.9 ppm is relatively weak and reduced accuracy due to poor signal:noise is acknowledged. However, the relative integral value of the peak at 4.9-5.2 ppm in each spectrum may be used to estimate the total % of ocimene alkene bonds epoxidised according to Equation (1.6):

$$\% of alkene bonds epoxidised = \frac{integral 1 - integral 2 \times 100}{integral 1} \qquad ( 1.6 )$$

where integral 1=integral of peak at 4.9-5.2 ppm in POc1 and integral 2=integral of peak at 4.9-5.2 ppm in EPOc1.

Using Equation (1.6) the estimated percentage of alkene bonds (noting that each repeat unit has two alkene bonds) which have been epoxidised in converting POC1 to EPOc1 is approximately 16.3%, which is in reasonable agreement with the target extent of epoxidation of 20%.

Calculating an accurate value of the extent of epoxidation selective for pendant trisubstituted double bonds is challenging—many of the peaks in the NMR spectrum are overlapping and almost every proton environment in the spectrum is effected by the epoxidation reaction. Consequently, selectivity of epoxidation of pendant trisubstituted double bonds is not provided.

### XIV. Chemoselectivity of the Epoxidation in Butadiene-Ocimene Block Copolymer

Epoxidation of a polybutadiene-polyocimene block copolymer PB-b-Oc1 was carried out by dissolving PB-b-Oc1 (0.44 g, 26.2 μmol) in chloroform (20 mL) before cooling to −10° C. After cooling, m-CPBA (0.25 g, 77% purity, 1.12 mmol, sufficient to epoxidise 100% of the pendant trisubstituted alkene residues of the ocimene repeat units) was dissolved in chloroform (10 mL) and slowly added to the polymer solution. This solution was stirred at −10° C. for 2.5 hours under argon. The reaction mixture was then washed with saturated NaHCO₃ solution before the organic layer was separated, dried with MgSO₄ and precipitated into a large excess of methanol. EPB-b-Oc1 (0.30 g, 66%) was collected and dried under reduced pressure.

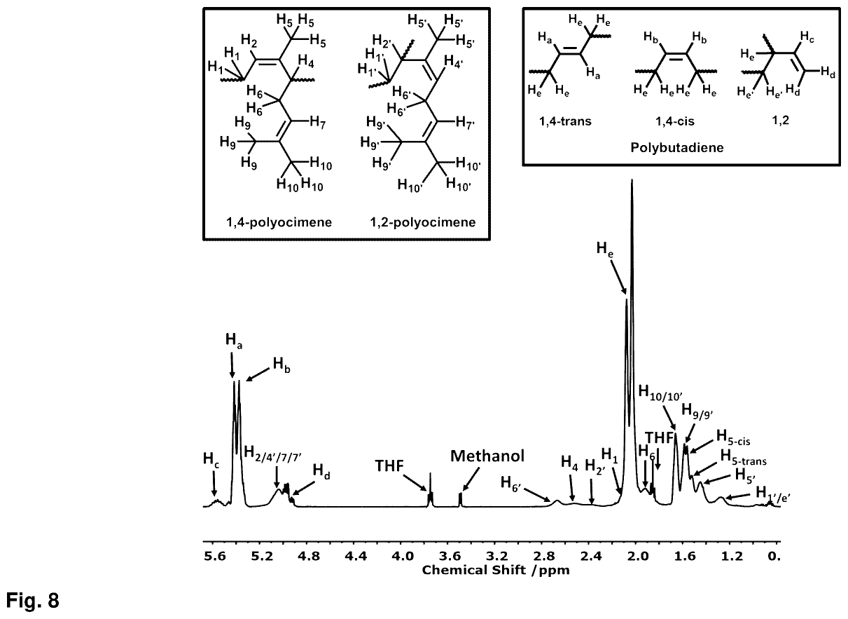

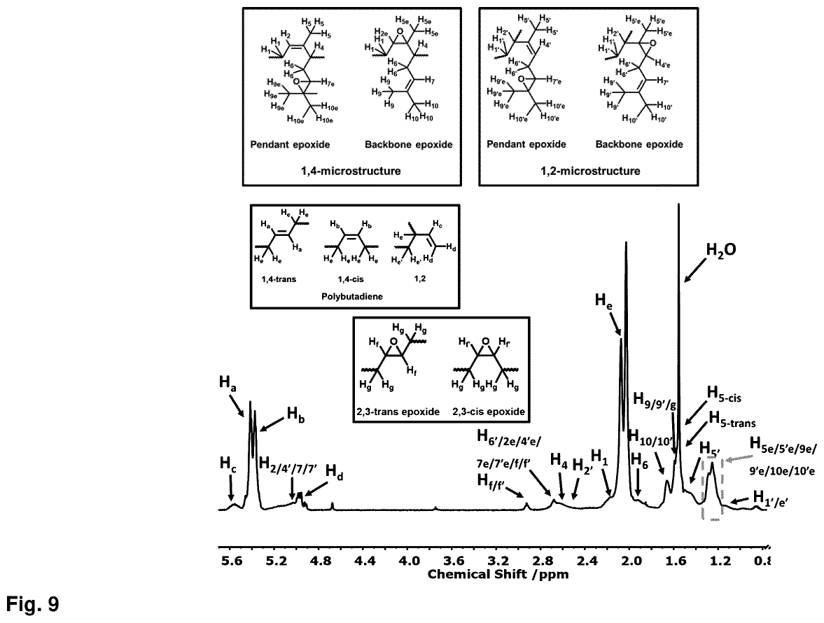

The extent and chemoselectivity of epoxidation towards ocimene and butadiene double bonds in PB-b-OC1 were calculated using NMR data (FIGS. 8 and 9). Signals appear in the NMR spectrum of EPB-b-Oc1 at approximately 1.2-1.35 ppm (within the box of FIG. 9). These signals correspond to methyl protons adjacent to an epoxide group—those formerly bonded to the ocimene alkene bonds. Thus, protons H₉/H₉, and H₁₀/H₁₀, have been transformed into H₉ₑ/H_{9′e}, and H₁₀ₑ/H_{10′e} (see insets of FIG. 9 for proton labels). The intensity of the new signal at approximately 1.2-1.35 ppm relative to the peaks assigned to H₉/H_{9′}, and H₁₀/H_{10′}, indicates that a significant proportion of the ocimene double bonds have been successfully epoxidised. It is worth recalling that PB-b-OC1 is 17.3 mol % ocimene and 82.7 mol % butadiene. Despite ocimene being a minor component of the copolymer, a significant proportion of its double bonds are epoxidised, thus there is a high degree of selectivity of epoxidation towards ocimene repeat units in preference to butadiene repeat units.

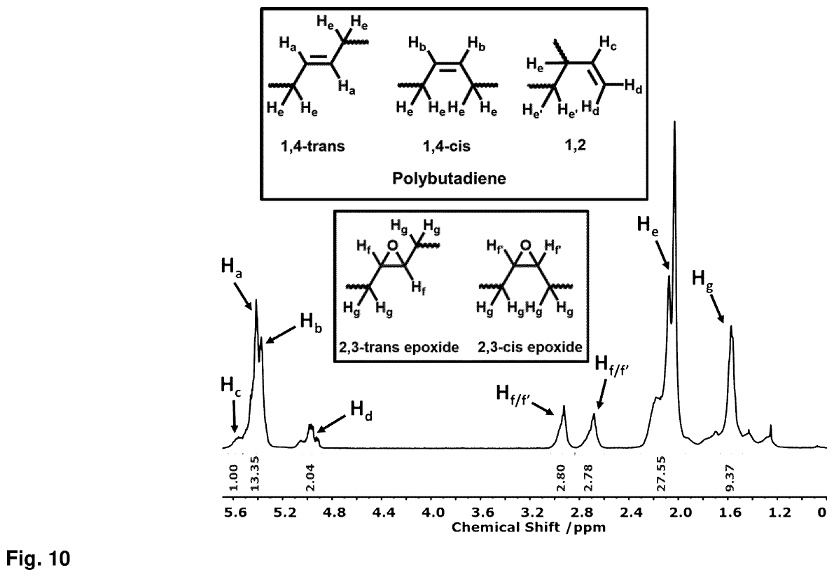

There is some evidence of epoxidation of butadiene repeat units. Epoxidation of a homopolymer of poly(butadiene) yielded EPB1. The NMR spectrum of EPB1 (FIG. 10) shows the emergence of new peaks corresponding to both the cis- and trans-epoxide of 1,4-poly(butadiene). Of particular interest are the proton signals that appear at approximately 2.7 and 2.95 ppm. There is some debate in the literature which of these peaks corresponds to the cis-epoxide and which to the trans-epoxide. However, of key relevance is that epoxidation of a sample of poly(butadiene), synthesised under almost exactly the same reaction conditions as those used to synthesise PB-b-Oc1, resulted in two peaks ascribable to the H_{f/f}, protons (see FIG. 10)—protons of the cis- and trans-epoxide, with almost identical integrals. The same two peaks are present in the NMR spectrum of EPB-b-Oc1 (FIG. 9), although the peak at approximately 2.7 ppm is overlapping with other signals.

The signals in FIG. 9 corresponding to epoxidised butadiene residues are very weak in intensity, indicating that the proportion of butadiene alkene bonds that are epoxidised is low, despite butadiene being the major component of the block copolymer. This further supports that epoxidation is selective towards trisubstituted alkenes, as observed on epoxidation of copolymers comprising myrcene.

Quantification of the chemoselectivity of epoxidation is complicated by the mixture of species in solution and the high degree of peak overlap in the resulting ¹H NMR spectrum. A simplified approach involves calculation of the extent of epoxidation of butadiene, and separately, calculation of the extent of epoxidation of ocimene. This is achieved by normalising all NMR signals relative to the integral of the peak corresponding to H_{c} of a 1,2-butadiene residue. It is assumed that the integral of this proton is largely unaffected by epoxidation: it is well known to those skilled in the art that a mono-substituted alkene such as that of a 1,2-butadiene residue is significantly less susceptible towards epoxidation by m-CPBA, than a disubstituted alkene such as that of a 1,4-butadiene residue.

The extent of epoxidation of polybutadiene may be estimated from the normalised integrals of relevant peaks. The sum of the integrals of the vinyl protons of butadiene residues (1 proton per residue) is given by Equation (1.7):

$$Sum of integrals of vinyl protons of butadiene residues = \frac{Integral of peak at 5.3 to 5.5 ppm}{2} + Integral of peak at 5.5 to 5.6 ppm \qquad ( 1.7 )$$

Thus the extent of epoxidation of the polybutadiene repeat units of EPB-b-Oc1, i.e. the percentage of polybutadiene alkene bonds converted to epoxide rings, is given by Equation (1.8):

$$( 1.8 )$$

$$\% epoxidation of polybutadiene alkene bonds = \frac{ \begin{matrix}Integral of peak at 2.9 ppm \\ ( proton of the cis \text{-} or trans \text{-} epoxide ) \times 100\end{matrix}}{Sum of integrals of vinyl protons of butadiene residues}$$

Using equations (1.7) and (1.8), a value of approximately 5.5% epoxidation of polybutadiene alkene bonds was obtained. This suggests that a small proportion of the alkene bonds of the polybutadiene block are epoxidised. This is especially small when considering that PB-b-POc1 comprises approximately 83 mol % butadiene.

The extent of epoxidation of polyocimene double bonds may be estimated in a similar manner. The difference in integral of the peak at 4.9-5.2 ppm before and after epoxidation is measured. This peak corresponds to 2 protons from each of the 1,4- (H₂ and Hz) and 1,2- (H_{4′}, and H₇) polyocimene residues, and the 2 H_{d} protons of the 1,2-polybutadiene residue (see inset of FIG. 9 for proton labels). The integral of the 2H_{d} protons must be equal to double the integral of the Hₑ proton of the same residue. Thus, the contribution of the H_{d} protons to the peak at 4.9-5.2 ppm may be removed by subtracting twice the integral of H_{c}. Thus in both the case of PB-b-Oc1 and EPB-b-Oc1, the integral arising from H₂, H₇, H_{4′} and H_{7′} is given by equation (1.9).

integral arising from H₂, H₇, H_{4′} and H_{7′}=Integral of peak at 4.9 to 5.2 ppm−(2×Integral of peak at 5.5 to 5.6 ppm) (1.9)

The difference in the integral arising from H₂, H₇, H_{4′} and H_{7′} in the ¹H NMR spectra of PB-b-Oc1 and EPB-b-Oc1 may be used to estimate the total % of epoxidised polyocimene alkene bonds using equation (1.10)—a modified version of equation (1.6).

$$\% of polyocimene alkene bonds epoxidised = \frac{integral A - integral B \times 100}{integral A} \qquad ( 1.10 )$$

where Integral A=integral arising from H₂, H₇, H_{4′}, and H_{7′} in POc1 and Integral B=integral arising from H₂, H₇, H₄, and H₇ in EPOc1.

According to equation (1.10), approximately 51.5% of polyocimene alkene bonds in EPB-b-Oc1 are epoxidised. Each ocimene repeat unit contains 2 trisubstituted alkene bonds and when epoxidising PB-b-Oc1, enough m-CPBA was added to epoxidise 100% of the pendant ocimene alkene bonds, or 50% of the total number of ocimene alkene bonds. Epoxidation of approximately 51.5% of polyocimene alkene bonds is greater than 100% conversion with a 100% selectivity of ocimene. This outcome reflects the error in method used to calculate the degree of epoxidation. However, even in view of this error, the combined results suggest a very high degree of epoxidation of the double bonds of polyocimene residues, a rather low degree of epoxidation of the double bonds of butadiene residues, and thus a high degree of chemoselectivity towards the trisubstituted alkene bonds of ocimene. Even though the block copolymer PB-b-Oc1 was more than 80 mol % butadiene, this data indicates that the vast majority of epoxidation occurred on the ocimene repeat units. This is in line with the qualitative evidence and expectations based on the results of analogous reactions on myrcene copolymers.

### XV. Post-Epoxidation Functional Group Modifications

The epoxide ring, which had been added with a high degree of selectivity to the 7,8, pendent alkene of myrcene-containing polymers, was investigated for utility as a platform to provide other functional groups, potentially allowing for the selective introduction of a host of new functionalities into the polymers, which in turn could allow tuning of the properties of the polymers. Such selective functionalisation could provide opportunities for the improvement of many different commercially, industrially and pharmaceutically used polymers, and is not limited to improving the wet grip and roll resistance properties of tyre rubbers (for a review of pharmaceutically used polymers, see W. Liechty et a., Annu. Rev. Chem. Biomol. Eng., 2010, 1, 149-173).

Epoxide ring-opening reactions were carried out on an epoxidised myrcene homopolymer. The original homopolymer (PM5) had a molar mass of 27,000 gmol⁻¹ and a microstructure comprising of 94% (4,1−) and 6% (4,3−). The homopolymer was epoxidised according to the same general method as describe above for the epoxidation of myrcene containing copolymers and yielded sample EPM9, in which 25% of all alkene double bonds of the polymyrcene homopolymer (PM5) had been epoxidised (69% 7,8 epoxidation and 31% 3,2 epoxidation). Two different nucleophiles were used for the ring-opening reactions:water and sodium azide.

NMR spectra of the resulting polymers were used to assess the degree of epoxide ring-opening, and in each case, the nucleophile was incorporated into the polymer, indicating that the epoxide ring had ring-opened. This suggests that the epoxide ring, which may be added with a high degree of selectivity to myrcene-containing copolymers, can be modified to incorporate other functional groups. This could allow for the manipulation of copolymer properties through the incorporation of different functional groups.

### XV.I Epoxide Ring-Opening Using Water as the Nucleophile

EPM9 (0.27 g, 10.0 μmol) was dissolved in toluene (20 mL) before being mixed with water (20 mL, 1.11 mol) to form a two phase system. Conc. HCl acid (5 mL, 165 mmol) was then added and the solution was stirred at 105° C. under nitrogen for 48 hours. The solvent was then removed under vacuum to yield a yellow gel (0.25 g, 86%) which was washed with water, methanol and acetone, and dried.

### XV.II Epoxide Ring-Opening Using Sodium Azide as the Nucleophile

EPM9 (0.26 g, 9.63 μmol) was dissolved in toluene (20 mL) before being mixed with water (20 mL, 1.11 mol) to form a two phase system. Glacial acetic acid (5 mL, 87.4 mmol), sodium azide (0.15 g, 2.31 mmol) and NH₄Cl (0.15 g) were then added and the solution was stirred at 105° C. under nitrogen for 48 hours. The solvent was then removed under vacuum to yield a yellow gel (0.25 g, 89%) which was washed with water, methanol and acetone, and dried.

### XV.III Epoxide Ring-Opening Using Lithium Aluminium Hydride as the Nucleophile

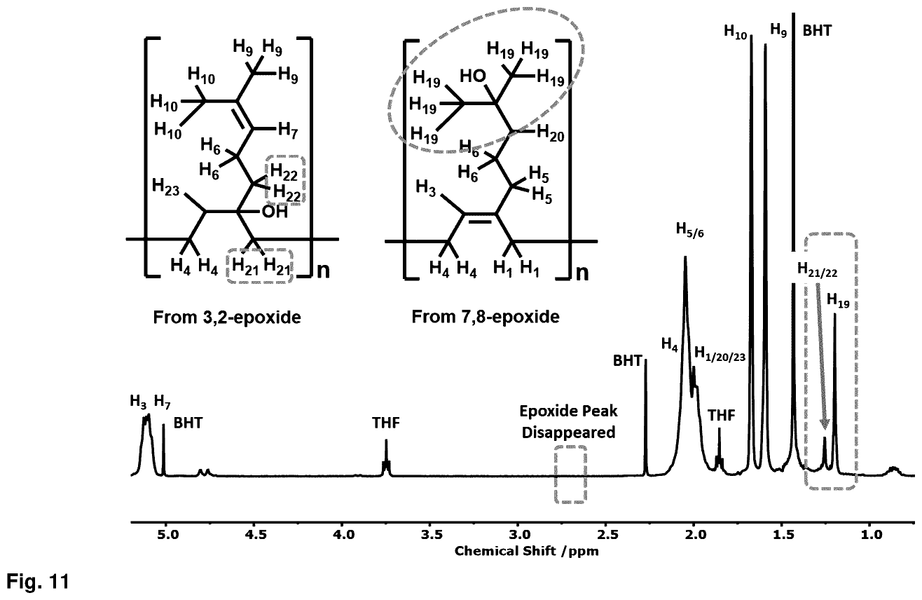

Epoxide ring-opening reactions using lithium aluminium hydride were carried out on an epoxidised myrcene homopolymer. The original homopolymer (PM6) had a molar mass of 11,000 gmol⁻¹ and a microstructure comprising of 93% (4,1−) and 7% (4,3−). The homopolymer was epoxidised according to the same general method as described above for the epoxidation of myrcene containing copolymers and yielded sample EPM10, in which 21% of all alkene double bonds of the polymyrcene homopolymer (PM6) had been epoxidised, with approximately 61% of the epoxidation occurring on the 7,8 double bond—see FIG. 11.

Lithium aluminium hydride was used for the ring-opening reactions according to Scheme (9).

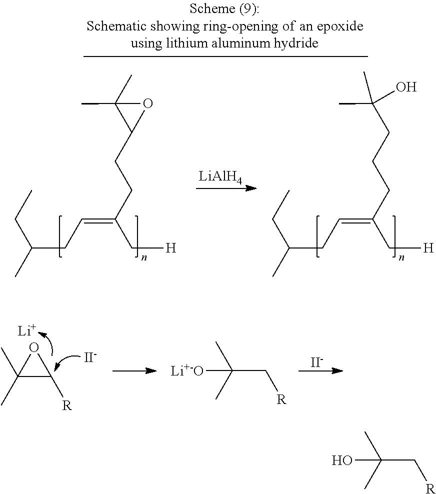

EPM10 (0.93 g, 21% epoxidation, 82.3 μmol) was dissolved in THF (5 mL), before removing the THF under vacuum. The polymer was further dried azeotropically by the addition and then removal by distillation of 10 ml benzene. This purification process was carried out twice before the polymer was dried under high vacuum for 18 hours. The polymer was then dissolved in dry, degassed benzene (30 mL) before LiAlH₄ solution (1 mL, 1.0 M in THF, 1 mmol) was added by injection. The reaction mixture was stirred at room temperature, under vacuum for 3 days to ensure complete ring-opening. Any residual hydride was destroyed by careful addition of the polymer solution, with stirring, to approximately 100 ml of methanol, which also resulted in precipitation of the polymer. The supernatant liquor was removed and the polymer was dissolved in 30 ml DCM before being transferred to a separating funnel. The polymer solution was washed firstly with dilute aqueous HCl (5 mL of 2 M in 50 mL of water), to protonate the alkoxide, and then dilute aqueous sodium bicarbonate solution (60 mL). The polymer was recovered from the organic layer by precipitation into methanol, separated from the liquor and then dried in vacuo to yield 0.57 g, 60%.

NMR spectra were used to confirm the successful epoxide ring-opening, which is evident by comparing the NMR spectra in FIG. 6 (prior to ring opening) and FIG. 11 (after treatment with LiAlH₄). It is clear that the relevant peaks in FIG. 6 at 2.7 ppm (H₁₄ and H₁₅), and at 1.25 ppm (H₁₇) and 1.30 ppm (H₁₆) are no longer present in the NMR spectrum of the ring-opened polymer (ROEPM10—FIG. 11). However, new peaks corresponding to the methyl (at 1.20 ppm (H₁₉)) and methylene (1.26 ppm (H₂₁ and H₂₂)) protons of the newly formed alcohols, can be observed in FIG. 11. The ratio of the integrals of these two peaks 1:2.4 is almost exactly what would be expected for the relative intensity of these two peaks, based on the mole fractions of 3,2 and 7,8 epoxide in EPM10 (1:1.56, giving an expected relative intensity of H_{21/22}:H₁₉ of 1:2.35). Further evidence to support the epoxidation and subsequent ring-opening can be seen in the IR spectra where the emergence of a band at c. 750 cm⁻¹ in the spectrum of EPM10 is ascribable to symmetric ring deformation. After treatment with LiAlH₄ the band at 750 cm⁻¹ disappears and a weak OH band appears at c. 3400 cm⁻¹, ascribable to ring-opening of the epoxide.

XVI. Impact of TMEDA on the Rate of Myrcene Incorporation into Polymers

It is well known that the statistical copolymerisation of styrene and butadiene results in a strongly tapered block copolymer when the polymerisation is carried out in a non-polar solvent such as benzene or cyclohexane. It is also well-known that the addition of small quantities of an ether (THF, DTHFP) or tertiary amine (TMEDA) to such a copolymerisation results in a random copolymer and such additives are known as randomisers. Solution styrene-butadiene rubber (sSBR) is a commercial random copolymer of styrene and butadiene, prepared by living anionic polymerisation in the presence of a randomiser.

The impact of TMEDA (tetramethylethylenediamine) on the copolymerisation kinetics of copolymers containing myrcene was investigated, with the expectation that a random copolymer would result when the polymerisation was carried out in the presence of a randomiser such as TMEDA.

### XVI.I Impact of TMEDA on the Statistical Copolymerisation of Myrcene and Styrene

A copolymer of myrcene and styrene (PMS1) was synthesised in benzene at room temperature. An initial molar monomer feed ratio of 49% myrcene, 51% styrene was used (see Synthetic procedures and characterisation, and Table 5). Samples were collected at 15, 60 and 1200 minutes to investigate the relative rate of consumption of the two monomers during the reaction. An analogous reaction was carried out in the presence of 2 mol. equivalents of TMEDA with respect to BuLi). The data in Table 5 shows how the consumption of each monomer varies as a function of time for each reaction. In the absence of TMEDA (PMS1) the copolymerisation proceeds in a qualitatively similar way to the copolymerisation of butadiene and styrene in a non-polar solvent. Thus, the diene (myrcene in this case) is preferentially consumed and a strongly tapered, block-like sequence results. However, in the presence of TMEDA (PMS(TMEDA)1), rather than the two monomers being consumed at the same rate, as would be expected for a random copolymer, a strong preference for the consumption of styrene is unexpectedly observed. Thus, a sample collected after 15 minutes had molar mass of 12,000 gmol⁻¹ and a composition of 92 mol % styrene

TABLE 5
Comparison of the composition of two myrcene/styrene statistical
copolymers, one synthesised in the absence of TMEDA (PMS1)
and one synthesised in the presence of TMEDA (PMS(TMEDA)1),
as a function of polymerisation reaction time.

| | Composition without TMEDA/ | | | Composition with TMEDA/ | | |
|---|---|---|---|---|---|---|
| Time/ | mol % (PMS1) | | | mol % (PMS(TMEDA)1) | | |
| min | Myrcene | Styrene | Mₙ/kgmol⁻¹ | Myrcene | Styrene | Mₙ/kgmol⁻¹ |
| 0 | 49 | 51 | — | 49 | 51 | — |
| 15 | 91 | 9 | 12.7 | 8 | 92 | 11.9 |
| 60 | 90 | 10 | 33.3 | 35 | 65 | 25.8 |
| 1200 | 49 | 51 | 80.7 | 45 | 55 | 32.6 |

### XVI.II Impact of DTHFP on Statistical Copolymerisation of Myrcene and Styrene

Similarly to § XVI, the impact of DTHFP on the copolymerisation kinetics of copolymers containing myrcene was investigated, with the expectation that a random copolymer would result when the polymerisation was carried out in the presence of such a randomiser. A copolymer of myrcene and styrene (PMS(DTHFP)1) was synthesised in benzene in the presence of DTHFP (4 mol equivalents of DTHFP with respect to the sec-BuLi). An initial molar monomer feed ratio of 47% myrcene, 53% styrene was used (see § XVII.VI for the procedure and characterisation, and Table 6). In a preliminary statistical copolymerisation of myrcene and styrene in the presence of DTHFP, it was observed that DTHFP resulted in a significant enhancement of the rate of reaction. Analysis indicated that this copolymerisation had almost reached completion after 15 mins and it was therefore not possible to draw meaningful conclusions about the copolymerisation kinetics from this initial experiment. Thus, when the copolymerisation was repeated to produce (PMS(DTHFP)1) the reaction was initially carried out a 0° C., to slow down the rate of reaction, and allow samples to be collected at low conversion. Thus, samples were collected for analysis after 5 and 20 mins (at 0° C.) before the reaction was allowed to proceed to completion at room temperature.

An analogous statistical copolymerisation reaction of myrcene and styrene was carried out in which the initial period (initiation and sampling) was carried out at 0° C. (PMS2) (see Synthetic procedures and characterisation, and Table 6) where an initial molar monomer feed ratio of 50% myrcene, 50% styrene was used and samples were collected at 20, 80 and 960 minutes to investigate the relative rate of consumption of the two monomers during the reaction in the absence of DTHFP. The data in Table 6 shows that in the absence of a polar additive, and at 0° C., the copolymerisation (PMS2) proceeds in a qualitatively similar way to the copolymerisation of butadiene and styrene in a non-polar solvent. Thus, the diene (myrcene in this case) is preferentially consumed and a strongly tapered, block-like sequence results. However, in the presence of DTHFP (PMS(DTHFP)1)—Table 6—the relative rate of consumption of the two monomers was rather similar to that observed in the presence of TMEDA (PMS(TMEDA)1—Table 5). Rather than the two monomers (myrcene and styrene) being consumed at the same rate, as would be expected for a random copolymer, a strong preference for the consumption of styrene is unexpectedly observed. Thus, a sample collected after 5 minutes (at 0° C.) had molar mass of 12,000 gmol⁻¹ and a composition of 93 mol % styrene. After 20 mins, the copolymer had reached a molar mass of 20,600 gmol⁻¹ (c. 44% conversion based on molar mass data) and yet comprised of 90 mol % styrene.

It is quite clear that in the presence of DTHFP, the resultant copolymer is not a random copolymer, but a tapered block copolymer, in which styrene is consumed in strong preference to myrcene.

TABLE 6
Comparison of the composition of two myrcene/styrene statistical
copolymers, one synthesised in the absence of DTHFP (PMS2) and
one synthesised in the presence of DTHFP (PMS(DTHFP)1), as a
function of polymerisation reaction time.

| Composition without DTHFP/ | | | | Composition with DTHFP/ | | | |
|---|---|---|---|---|---|---|---|
| mol % (PMS2) | | | | mol % (PMS(DTHFP)1) | | | |
| Time/ | | | Mn/ | Time/ | | | Mn/ |
| min | Myrcene | Styrene | kgmol⁻¹ | min | Myrcene | Styrene | kgmol⁻¹ |
| 0 | 50 | 50 | — | 0 | 47 | 53 | — |
| 20 | 78 | 22 | — | 5 | 7 | 93 | 12.0 |
| 80 | 84 | 16 | 4.2 | 20 | 10 | 90 | 20.6 |
| 960 | 48 | 52 | 40.8 | 120 | 44 | 56 | 47.0 |

To further illustrate this point a second analogous statistical copolymerisation reaction of myrcene and styrene was carried out in the presence of 2 mole equivalents of DTHFP with respect to sec-BuLi (PMS(DTHFP)2) (see Synthetic procedures and characterisation, and Table 7). Once again, the presence of 2 equivalents (w.r.t sec-BuLi) of DTHFP impacts the relative rate of consumption of the two monomers in a very similar fashion to that observed for the copolymerisation of the same monomers in the presence of 4 equivalents (w.r.t sec-BuLi) (PMS(DTFHP)1). Thus rather than the two monomers (myrcene and styrene) being consumed at the same rate, as would be expected for a random copolymer, a strong preference for the consumption of styrene is again observed.

TABLE 7
Composition of a myrcene/styrene statistical copolymer,
polymerised in the presence of 2 eq. DTHFP (PMS(DTHPF)2),
as a function of polymerisation reaction time.
Composition with DTHFP/mol % (PMS(DTHFP)2)

| Time/min | Myrcene | Styrene | Mₙ/kgmol⁻¹ |
|---|---|---|---|
| 0 | 50 | 50 | — |
| 5 | 9 | 91 | 13.8 |
| 15 | 10 | 90 | 25.7 |
| 960 | 42 | 58 | 84.3 |

XVI.III Impact of TMEDA on the Statistical Copolymerisation of Myrcene and butadiene

A copolymer of myrcene and butadiene (PMB2) was also synthesised in benzene at room temperature. An initial molar monomer feed ratio of 43% myrcene and 57% styrene was used (see Synthetic procedures and characterisation, and Table 8). Samples were collected at 15, 60 and 1200 minutes to investigate the relative rate of consumption of the two monomers during the reaction. An analogous reaction was carried out in the presence of 2 mol. equivalents of TMEDA with respect to BuLi. The data in Table 8 shows how the consumption of each monomer varies as a function of time for each reaction. In the absence of TMEDA (PMB2) the copolymerisation proceeds in an almost random fashion with perhaps a slight preference for the consumption of myrcene. Thus after 15 minutes a sample collected from PMB2 had achieved a molar mass of 3,000 gmol⁻¹ and had a composition of 49 mol % myrcene, compared with 43 mol % myrcene in the feed. However, in the presence of TMEDA (PMB(TMEDA)1), rather than the two monomers being consumed at the same rate, as would be expected for a random copolymer, a preference for the consumption of butadiene is observed. Thus, a sample collected after 15 minutes had molar mass of 25,600 gmol⁻¹ and a composition of 72 mol % butadiene in comparison to 54 mol % butadiene in the feed.

TABLE 8
Comparison of the composition of two myrcene/butadiene statistical
copolymers, one synthesised in the absence of TMEDA (PMB2) and
one synthesised in the presence of TMEDA (PMB(TMEDA)1),
as a function of polymerisation reaction time.

| | Composition without TMEDA/ | | | Composition with TMEDA/ | | |
|---|---|---|---|---|---|---|
| | mol % (PMB2) | | | mol % (PMB(TMEDA)1) | | |
| Time/ | | | Mₙ/ | | | Mₙ/ |
| min | Myrcene | Butadiene | kgmol⁻¹ | Myrcene | Butadiene | kgmol⁻¹ |
| 0 | 43 | 57 | — | 46 | 54 | — |
| 15 | 49 | 51 | 3.0 | 28 | 72 | 25.6 |
| 60 | 47 | 53 | 12.2 | 38 | 62 | 34.3 |
| 1200 | 43 | 57 | 36.1 | 43 | 57 | 39.8 |

### XVI.IV Impact of TMEDA on the Statistical Terpolymerisation of Myrcene, Butadiene and Styrene

A terpolymer of myrcene, butadiene and styrene (PMBS(TMEDA)1) was synthesised in benzene at room temperature, with the addition of TMEDA. It had been expected that in the presence of TMEDA a random copolymer of myrcene, butadiene and styrene would result. An initial monomer molar feed ratio of 35% myrcene, 33% butadiene and 32% styrene was used, which corresponded to 4.12 g of myrcene, 1.55 g of butadiene and 2.85 g of styrene. The monomers were mixed with 0.032 mL of TMEDA (2 mol. equivalents of TMEDA with respect to BuLi) before initiation with 0.152 mL of sec-BuLi to synthesise a random terpolymer with a target Mₙ of 40,000 g mol⁻¹. Samples were collected for analysis after 15, 60 and 1440 minutes to investigate the relative rate of consumption of the three monomers and to investigate whether the resulting terpolymer had a random monomer sequence distribution. The results (shown in Table 9) were compared to the results of an analogous terpolymerisation which was carried out in the absence of any TMEDA (PMBS1). PMBS1 had a monomer molar feed ratio of 28% myrcene, 38% butadiene and 34% styrene and a target Mₙ of 80,000 gmol⁻¹.

TABLE 9
Comparison of the composition of two terpolymers, one synthesised
in the absence of TMEDA (PMBS1) and one synthesised in the
presence of TMEDA (PMBS(TMEDA)1), as a function of time.

| | Composition without TMEDA/ | | | | Composition with TMEDA/ | | | |
|---|---|---|---|---|---|---|---|---|
| | mol % (PMBS1) | | | | mol % (PMBS(TMEDA)1) | | | |
| Time/ | | | | Mn/ | | | | Mn/ |
| min | Myr | Bd | Sty | kgmol⁻¹ | Myr | Bd | Sty | kgmol⁻¹ |
| 0 | 28 | 38 | 34 | — | 35 | 33 | 32 | — |
| 15 | 38 | 55 | 7 | 4.9 | 14 | 45 | 41 | 17.6 |
| 60 | 39 | 54 | 7 | 20.1 | 26 | 40 | 34 | 32.3 |
| 1440 | 28 | 38 | 34 | 95.3 | 35 | 33 | 32 | 41.1 |

In the absence of TMEDA (PMBS1) the terpolymerisation proceeds qualitatively in line with expectations based on the results reported above for copolymers PMS1 and PMB2 (Tables 3 and 4). Thus in PMBS1 the myrcene and butadiene copolymerise in an almost random fashion and in preference to styrene. Thus after 60 minutes the terpolymer has reached a molar mass of 20,100 gmol⁻¹ and has a composition (mol %) comprising of 39% myrcene, 54% butadiene and only 7% styrene compared to a feed molar ratio of 28% myrcene, 38% butadiene and 34% styrene. However, in the presence of randomiser TMEDA (PMBS(TMEDA)1), the expectation that the three monomers would be consumed at the same rate, as would be expected for a random terpolymer, was not observed. The results in Table 9 indicate that in the presence of TMEDA the butadiene and styrene monomers are consumed at almost the same rate. This is consistent with previously discussed literature (see H. L. Hsieh & R. P. Quirk, supra). However, the myrcene is consumed at a much slower rate than the other two monomers. Thus after 15 minutes the terpolymer has reached a molar mass of 17,600 gmol⁻¹, almost half the final molar mass of 41,000 gmol⁻¹, and has a composition (mol %) comprising of 14% myrcene, 45% butadiene and 41% styrene compared to a feed molar ratio of 35% myrcene, 33% butadiene and 32% styrene. Clearly myrcene is not incorporated randomly but is consumed preferentially towards the end of the polymerisation. Hence this compositional drift will result in a tapered block-like sequence with clustering of myrcene towards the terminating end of the polymer chain.

A publication by the Deuri group has previously described the anionic terpolymerisation of isoprene, butadiene and styrene, in the presence of TMEDA, which resulted in a random terpolymer (see R. Sengupta et a., Engineering, 2007, 47, 21-25). Isoprene and myrcene are electronically similar, thus it would be expected that anionic terpolymerisation of myrcene, butadiene and styrene in the presence of TMEDA would also result in a random terpolymer. The initial preferential uptake of butadiene and styrene over myrcene is a completely unexpected observation. However, these observations are in line with the results of the copolymerisation of myrcene with styrene in the presence of TMEDA (PMS(TMEDA)1) in Table 5, and the results of the copolymerisation of myrcene with butadiene in the presence of TMEDA (PMB(TMEDA)1) in Table 8.

In each case there was a reduced rate of myrcene incorporation into the polymer in comparison to the analogous reaction carried out in the absence of TMEDA, rather than an equal rate of incorporation as would be expected for a random copolymer.

### XVII. Synthetic Procedures and Characterisation

### XVII.I Myrcene-Isoprene Block Copolymer —PM-b-11

4.57 g of myrcene was initiated with 0.326 mL of sec-BuLi. After 3 hours 5.43 g of isoprene was added to synthesise a copolymer with a target Mₙ of 21,900 g mol⁻¹. The sample was terminated 19 hours after initiation. A clear gel was recovered (8.36 g, 86%); Mₙ—22,700 g mol⁻¹, M_{w}—23,400 g mol⁻¹, Ð—1.03; δ_{H} (400 MHz, CDCl₃) 5.05-5.17 (H₃ & H₇), 4.78 (H₁₁), 1.92-2.13 (H₄ & H_{5/6}& H₁), 1.67 (H₁₀), 1.59 (H₉).

### XVII.II Myrcene-Butadiene Block Copolymer—PM-b-B1

5.02 g of myrcene was used and initiated with 0.717 mL of BuLi to initially synthesise a polymyrcene block. A sample was collected for analysis after 4 hours (PM-b1). To the remaining reaction mixture, 4.60 g of butadiene was added and the reaction allowed to proceed for a further 21 hours before the reaction was terminated with methanol. A viscous sticky solid was recovered (PM-b-B1) (7.27 g, 79%) and analysed; PM-b1—Mₙ—4,800 g mol⁻¹, M_{w}—5,200 g mol⁻¹, Ð—1.08; 93% (4,1), 7% (4,3); δ_{H} (400 MHz, CDCl₃) 5.05-5.17 (H₃ & H₇), 4.78 (H₁₁), 1.92-2.13 (H₄ & H_{5/6}& H₁), 1.67 (H₁₀), 1.59 (H₉).

PM-b-B1—Mₙ—8,500 g mol⁻¹, M_{w}—8,800 g mol⁻¹, Ð—1.04 (as calculated by SEC using a dn/dc value of 0.1240); myrcene 37% (7% (4,3), 93% (4,1)), 63% butadiene (11% (1,2), 40% (1,4)-Trans, 49% (1,4)-Cis); δ_{H} (400 MHz, CDCl₃) 5.51-5.62 (H_{C}), 5.42 (H_{A}), 5.38 (H_{B}), 5.08-5.17 (H₃& H₇), 4.90-5.01 (H_{D}), 4.78 (H₁₁), 1.90-2.13 (H₄ & H_{5/6}& H₁ & H_{E}), 1.67 (H₁₀), 1.59 (H₉).

### XVII.III Myrcene-Butadiene Statistical Copolymers

PMB1—In a typical reaction 5.79 g of myrcene was mixed with 6.53 g of butadiene and initiated with 0.147 mL of sec-BuLi to synthesise a statistical copolymer with a target Mₙ of 60,000 g mol⁻¹. The polymerisation was terminated after 1200 minutes to yield a clear viscous semi-solid (9.76 g, 86%); Mₙ—58,000 g mol⁻¹, M_{w}—59,700 g mol⁻¹, Ð—1.03 (as calculated by SEC using a dn/dc value of 0.126); 74% butadiene (13% (1,2), 47% (1,4)-cis, 40% (1,4)-trans), 26% myrcene (93% (4,1), 7% (4,3)); δ_{H}(400 MHz, CDCl₃) 5.51-5.62 (H_{C}), 5.42 (H_{A}), 5.38 (H_{B}), 5.08-5.17 (H₃& H₇), 4.90-5.01 (H_{D}), 4.78 (H₁₁), 1.90-2.13 (H₄ & H_{5/6}& H₁ & H_{E}), 1.67 (H₁₀), 1.59 (H₉).

PMB2—3.81 g of myrcene was mixed with 1.98 g of butadiene and initiated with 0.103 mL of sec-BuLi to synthesise a statistical copolymer with a target Mₙ of 40,000 g mol⁻¹. Sample was terminated after 1200 minutes to yield a clear semi-solid (3.57 g, 83%); Mₙ—36,100 g mol⁻¹, M_{w}—37,200 g mol⁻¹, Ð—1.03 (as calculated by SEC using a dn/dc value of 0.127); 57% butadiene (14% (1,2), 46% (1,4)-cis, 40% (1,4)-trans), 43% myrcene (93% (4,1), 7% (4,3)).

PMB3—0.56 g of myrcene was mixed with 5.63 g of butadiene and initiated with 0.147 mL of sec-BuLi to synthesise a statistical copolymer with a target Mₙ of 40,000 g mol⁻¹. Sample was terminated after 1200 minutes to yield a viscous semi-solid (5.74 g, 93%); Mₙ—40,200 g mol⁻¹, M_{w}—41,300 g mol⁻¹, Ð—1.03 (as calculated by SEC using a dn/dc value of 0.124); 95% butadiene (23% (1,2), 45% (1,4)-cis, 32% (1,4)-trans), 5% myrcene (88% (4,1), 12% (4,3)).

PMB4—0.34 g of myrcene was mixed with 2.43 g of butadiene and initiated with 0.099 mL of sec-BuLi to synthesise a statistical copolymer with a target Mₙ of 20,000 g mol⁻¹. Sample was terminated after 960 minutes to yield a viscous semi-solid (1.95 g, 81%); Mₙ—16,800 g mol⁻¹, M_{w}—17,400 g mol⁻¹, Ð—1.03 (as calculated by SEC using a dn/dc value of 0.126); 92% butadiene (11% (1,2), 49% (1,4)-cis, 40% (1,4)-trans), 8% myrcene (92% (4,1), 8% (4,3)).

XVII.IV Myrcene-Butadiene Statistical Copolymer—with Randomiser

PMB(TMEDA)1—5.15 g of myrcene was mixed with 2.4 g of butadiene, 0.18 mL of TMEDA and initiated with 0.180 mL of sec-BuLi to synthesise a statistical copolymer with a target Mₙ of 30,000 g mol⁻¹. Sample was terminated after 1200 minutes to yield a viscous semi-solid (5.32 g, 83%); Mₙ—39,800 g mol⁻¹, M_{w}—41,000 g mol⁻¹, Ð—1.03 (as calculated by SEC using a dn/dc value of 0.127); 57% butadiene (74% (1,2), 26% (1,4)), 43% myrcene (25% (4,1), 75% (4,3)).

### XVII.V Myrcene-Styrene Statistical Copolymer

PMS1—In a typical reaction 3.21 g of myrcene was mixed with 2.58 g of styrene and initiated with 0.059 mL of sec-BuLi to synthesise a statistical copolymer with a target Mₙ of 70,000 g mol⁻¹. Sample was terminated after 1200 minutes to yield a semi-solid (3.88 g, 83%); Mₙ—80,700 g mol⁻¹, M_{w}—86,800 g mol⁻¹, Ð—1.08 (as calculated by SEC using a dn/dc value of 0.159); 51% styrene, 49% myrcene (93% (4,1), 7% (4,3)); δ_{H} (400 MHz, CDCl₃) 7.90-7.25 (H₆ & H_{E}), 6.35-6.76 (H_{γ}), 5.08-5.17 (H₃& H₇), 4.78 (H₁₁), 1.90-2.13 (H₄ & H_{5/6}& H₁ & H_{α}& H_{β}), 1.85 (H₁₂), 1.67 (H₁₀), 1.59 (H₉).

PMS2—Myrcene (4.74 g) was mixed with styrene (3.64 g) and initiated with 0.19 mL of sec-BuLi to synthesise a statistical copolymer with a target Mₙ of 30,000 g mol⁻¹. The polymerisation was initiated at 0° C. and the solution maintained at this temperature for 80 minutes, after which the reaction was allowed to rise to room temperature. The reaction was then left to stir for RT. Sample was terminated after 960 minutes to yield a semi-solid (6.98 g, 88%); Mₙ —40,800 g mol⁻¹, M_{w}—44,300 g mol⁻¹, Ð—1.09 08 (as calculated by SEC using a dn/dc value of 0.157); 52% styrene, 48% myrcene (82% (4,1), 18% (4,3))

XVII.VI Myrcene-Styrene Statistical Copolymer—with Randomiser

PMS(TMEDA)1—4.80 g of myrcene was mixed with 3.82 g of styrene and 0.18 mL of TMEDA and initiated at room temperature with 0.205 mL of sec-BuLi to synthesise a statistical copolymer with a target Mₙ of 30,000 g mol⁻¹. Sample was terminated after 1200 minutes to yield a white powder (4.62 g, 74%); Mₙ—32,600 g mol⁻¹, M_{w}—35,300 g mol⁻¹, Ð—1.08 (as calculated by SEC using a dn/dc value of 0.161); 55% styrene, 45% myrcene (43% (4,1), 57% (4,3)).

PMS(DTHFP)1—4.33 g (0.032 mol) of myrcene was mixed with 3.78 g (0.036 mol) of styrene and 0.12 mL (648 μmol) of DTHFP and initiated with 0.12 mL (162 μmol) of sec-BuLi (1.4 mol dm⁻³ in cyclohexane) to synthesise a statistical copolymer with a target Mₙ of 50,000 g mol-1. The solution was initially maintained at 0° C. and samples collected for analysis after 5 and 20 mins. The reaction was then allowed to rise to room temperature and allowed to proceed, with stirring, to give a final/total reaction time of 2 hours. The sample was terminated after this time to yield a white solid (6.78 g, 84%); Mₙ—47,000 g mol⁻¹, M_{w}—49,600 g mol⁻¹, Ð—1.06 (as calculated by SEC using a dn/dc value of 0.161); 56% styrene, 44% myrcene (32% (4,1), 68% (4,3)).

PMS(DTHFP)2—4.74 g, (0.034 mol) of myrcene was mixed with 3.64 g, (0.035 mol) of styrene and 0.0634 mL (336 μmol) DTHFP and initiated with 0.12 mL (168 μmol) of sec-BuLi, 1.4 mol dm⁻³ in cyclohexane), which was injected via syringe, to synthesise a polymer with a target Mₙ of 50,000 g mol⁻¹. The solution was initially maintained at 0° C. and samples collected for analysis after 5 and 15 mins. The reaction was then allowed to rise to room temperature and allowed to proceed, with stirring, to give a final/total reaction time of 16 hours. The sample was terminated after this time to yield a white solid (7.65 g, 93%); Mₙ—84,300 g mol⁻¹, M_{w}—97,400 g mol⁻¹, Ð—1.16 (as calculated by SEC using a dn/dc value of 0.167); 58% styrene, 42% myrcene (35% (4,1), 65% (4,3)).

### XVII.VII Myrcene-Butadiene-Styrene Statistical Terpolymer

PMBS1—5.10 g of myrcene was mixed with 2.76 g of butadiene and 4.88 g of styrene before being initiated with 0.114 mL of sec-BuLi to synthesise a statistical terpolymer with a target Mₙ of 80,000 g mol⁻¹. Sample was terminated after 1440 minutes to yield a white solid (8.61 g, 75%); Mₙ—95,300 g mol⁻¹, M_{w}—100,100 g mol⁻¹, Ð—1.05 (as calculated by SEC using a dn/dc value of 0.147); 34% styrene, 38% butadiene (17% (1,2), 50% (1,4)-Cis, 33% (1,4)trans), 28% myrcene (89% (4,1), 11% (4,3)).

XVII.VIII Myrcene-Butadiene-Styrene Statistical Terpolymer—with Randomiser

PMBS(TMEDA)1—4.12 g of myrcene was mixed with 1.55 g of butadiene and 2.85 g of styrene and 0.032 mL of TMEDA before being initiated with 0.152 mL of sec-BuLi to synthesise a statistical terpolymer with a target Mₙ of 40,000 g mol⁻¹. Sample was terminated after 1440 minutes to yield a clear semi-solid (5.41 g, 84%); Mₙ—41,100 g mol⁻¹, M_{w}—42,900 g mol⁻¹, Ð—1.04 (as calculated by SEC using a dn/dc value of 0.146); 32% styrene, 33% butadiene (22% (1,2), 25% (1,4)-trans, 53% (1,4)-cis), 35% myrcene (16% (4,1), 84% (4,3)).

PMBS(TMEDA)2—0.47 g of myrcene was mixed with 3.19 g of butadiene and 1.81 g of styrene and 0.05 mL of TMEDA before being initiated with 0.13 mL of sec-BuLi to synthesise a statistical terpolymer with a target Mₙ of 30,000 g mol⁻¹. Sample was terminated after 1440 minutes to yield a semi-solid (4.41 g, 81%); Mₙ—34,500 g mol⁻¹, M_{w}—35,400 g mol⁻¹, Ð—1.03 (as calculated by SEC using a dn/dc value of 0.135); δ_{H}(400 MHz, CDCl₃) 7.90-7.25 (H₆ & H_{E}), 6.35-6.76 (H_{γ}), 5.51-5.62 (H_{C}), 5.42 (H_{A}), 5.38 (H_{B}), 5.08-5.17 (H₃& H₇), 4.90-5.01 (H_{D}), 4.78 (H₁₁), 1.90-2.13 (H₄ & H_{5/6}& H₁ & H_{E} & H_{α}& H_{β}), 1.67 (H₁₀), 1.59 (H₉).

### XVII.IX Myrcene-Isoprene-4-Methylstyrene Statistical Terpolymer

PM14MS1—A monomer mixture of 803.9 mg (11.8 mmol) isoprene, 1071.8 mg (7.87 mmol) myrcene and 2324.3 mg (19.7 mmol) 4-methylstyrene was dried over CaH₂ under an argon atmosphere and degassed by three freeze-thaw cycles. Cyclohexane was dried by titration with styrene and sec-butyllithium and degassed by three freeze-thaw cycles. The monomer mixture and cyclohexane were cryo transferred into a round bottom flask equipped with a rubber septum and a magnetic stirrer bad. 0.05 ml of the initiator (1.4 M sec-Butyllithium) were added via syringe and the copolymer solution was stirred overnight. The polymerisation was terminated by adding 0.5 ml of degassed isopropyl alcohol via syringe and precipitated in a 10-fold access of isopropyl alcohol, containing a small amount of BHT as stabilizer.

### XVII.X Ocimene Homopolymer

POc1—ocimene (6.37 g), dried and degassed over calcium hydride, was further purified by the addition of n-BuLi solution (0.10 mL) immediately before distillation into a reaction flask containing toluene (100 mL). The polymerisation was initiated with sec-BuLi (0.38 mL) for a target molar mass of 12,000 gmol⁻¹. The polymerisation was terminated after 3 hours to yield a sticky solid (4.19 g, 66%); Mₙ—26,300 g mol⁻¹, M_{w}—43,500 g mol⁻¹, Ð—1.65 (as calculated by SEC using a dn/dc value of 0.128); (71% 1,4-, 29% 1,2-).

### XVII.XI Butadiene-Ocimene Block Copolymer

PB-b-Oc1—butadiene (2.50 g) was mixed with benzene (˜150 mL) before being initiated with sec-BuLi (0.18 mL) with a target block Mₙ of 10,000 g mol⁻¹. The solution was stirred for 16 hours at room temperature, ensuring full monomer conversion, before the addition of ocimene (1.88 g), purified as above, to produce a block copolymer with a target Mₙ of 17,400 g mol⁻¹. The solution was stirred for a further 20 hours before polymerisation was terminated to yield a sticky solid (3.39 g, 77%); Mₙ—16,800 g mol⁻¹; M_{w} —27,200 g mol⁻¹, Ð=1.62 (as calculated by SEC using a dn/dc value of 0.125); 82.7% butadiene (12.2% 1,2, 39.9% 1,4-trans, 47.9% 1,4-cis), 17.3% ocimene (68.4% 1,4-, 31.6% 1,2-).

1. A method comprising effecting an epoxidation reaction on a first copolymer, to provide a second copolymer comprising epoxide groups, wherein the first copolymer is a block and/or tapered block copolymer which is derived from at least three different types of monomer and comprises a backbone from which hydrocarbyl, trisubstituted ethylene-containing moieties are pendant.

2. The method of claim 1, wherein the first copolymer is a terpolymer.

3. The method of claim 1, wherein the first copolymer is a copolymer of myrcene, trans-β-farnesene, trans-β-ocimene and/or cis-β-ocimene.

4. The method of claim 1, wherein the first copolymer is a copolymer of butadiene, styrene optionally substituted at one or more positions with a C₁-C₆ aliphatic or aromatic hydrocarbyl, isoprene, and/or 2,3-dimethyl-1,3-butadiene.

5. The method of claim 4, wherein the styrene optionally substituted at one or more positions with a C₁-C₆ aliphatic or aromatic hydrocarbyl is styrene, 4-methylstyrene, α-methylstyrene, para,α-dimethylstyrene, and/or 1,1-diphenylethylene.

6. The method of claim 1, wherein the first copolymer is a copolymer of butadiene, styrene and/or isoprene.

7. The method of claim 1, wherein the first copolymer is a copolymer of butadiene and/or styrene.

8. The method of claim 7, wherein the first copolymer is a copolymer of butadiene.

9. The method of claim 1, wherein the first copolymer is a copolymer of butadiene, styrene and myrcene, butadiene, styrene and trans-β-farnesene, butadiene, styrene and trans-β-ocimene or butadiene, styrene and cis-β-ocimene.

10. The method of claim 1, wherein the first copolymer is a copolymer of myrcene.

11. The method of claim 1, wherein the first copolymer is a copolymer of butadiene, styrene and myrcene.

12. The method of claim 1, wherein the first copolymer is a block copolymer.

13. The method of claim 1, wherein the first copolymer is a tapered block copolymer.

14. The method of claim 1, wherein the first copolymer is linear.

15. The method of claim 1, wherein the pendant hydrocarbyl, trisubstituted ethylene-containing moieties are in one block or tapered block situated at one end of the first copolymer, or wherein the pendant hydrocarbyl, trisubstituted ethylene-containing moieties are in two blocks, two tapered blocks, or one block and one tapered block with each situated on opposite ends of the first copolymer.

16. The method of claim 15, wherein the first copolymer further comprises a block of randomly distributed comonomers.

17. The method of claim 1, wherein the epoxidation reaction is effected by reacting the first copolymer with a peroxy acid.

18. The method of claim 17, wherein the peroxy acid is 3-chloroperbenzoic acid.

19. The method of claim 1, wherein the method further comprises, before the epoxidation reaction, preparing the first copolymer by anionic polymerisation.

20. The method of claim 19, wherein at least a part of the anionic polymerisation is conducted in the presence of a randomising agent.

21. The method of claim 20, wherein the randomising agent is selected from the group consisting of N,N,N′,N′-tetramethylethylenediamine, 2,2-di(tetrahydrofuryl)propane and tetrahydrofuryl ethyl ether.

22. (canceled)

23. The method of claim 19 wherein the anionic polymerisation comprises a terminating step comprising introducing a halosilane into the anionic polymerisation reaction.

24. The method of claim 1, further comprising reacting at least some of the epoxide groups with a nucleophile to provide a third copolymer.

25. The method of claim 24, wherein the nucleophile is selected from the group consisting of a hydride, water and sodium azide.

26-31. (canceled)

32. A copolymer obtainable according to the method of claim 1.

33. The copolymer of claim 32, which is a third copolymer provided by a method further comprising reacting at least some of the epoxide groups with a nucleophile.

34. The copolymer of claim 32, which is a solution styrene butadiene rubber.

35. A method of preparing a copolymer by anionic polymerisation, wherein the copolymer is a first copolymer as defined in claim 1, and the anionic polymerisation is conducted in the presence of a randomising agent.

36. A copolymer, which is a first copolymer obtainable by the method of claim 35.

37. A curable composition comprising:
(i) a solution styrene butadiene rubber as defined in claim 34; and
(ii) a filler material.

38-39. (canceled)

40. An article resultant from curing of the composition of claim 37.

41. The article of claim 40, which is a tyre.
